(19) United States
(12) Patent Application Publication
(10) Pub. No.: US 2026/0075403 A1
(43) Pub. Date: Mar. 12, 2026

(54) UPLINK AND DOWNLINK DATA AND CONTEXT HANDLING FOR ROAMING

(71) Applicant: Cisco Technology, Inc., San Jose, CA (US)

(72) Inventors: Binita GUPTA, San Diego, CA (US); Brian D. HART, Sunnyvale, CA (US); Malcolm M. SMITH, Richardson, TX (US)

(21) Appl. No.: 19/390,399

(22) Filed: Nov. 14, 2025

Related U.S. Application Data
(63) Continuation of application No. 19/227,259, filed on Jun. 3, 2025.
(60) Provisional application No. 63/762,540, filed on Feb. 24, 2025.
(60) Provisional application No. 63/655,523, filed on Jun. 3, 2024.

(51) Int. Cl. H04W 8/14

(52) U.S. Cl. CPC H04W 8/14

(57) ABSTRACT

The present disclosure provides techniques for seamless roaming with uplink/downlink context transfer. A first AP MLD of a SMD establishes an association between the SMD and a non-AP MLD, receives UL MPDUs from the non-AP MLD, each UL data MPDU having a corresponding SN, transmits content of the UL data MPDUs received from the non-AP MLD to a distribution system, maintains UL context information of the association, receives a roaming request from the non-AP MLD, transfers UL context information to the second AP MLD, the UL context information comprising a SN of the last UL data MPDU received from, and acknowledged to, the non-AP MLD and forwarded to the distribution system, and transmits a roaming response to the non-AP MLD, the roaming response comprising an indication of the SN of the last UL data MPDU received from, and acknowledged to, the non-AP MLD and forwarded to the distribution system.

### CROSS-REFERENCE TO RELATED APPLICATIONS

This application is a continuation of United States co-pending patent applications Serial No. 19/227,259 filed June 3, 2025, which claims benefit of United States provisional patent applications Serial No. 63/762,540 filed February 24, 2025 and Serial No. 63/655,523 filed June 3, 2024. The aforementioned related patent applications are herein incorporated by reference in their entirety.

### TECHNICAL FIELD

Embodiments presented in this disclosure generally relate to wireless communication. More specifically, embodiments disclosed herein relate to uplink (UL) and downlink (DL) context transfer and data flushing for seamless roaming.

### BACKGROUND

In wireless local area networks (WLANs) supporting multi-link operation (MLO), a station multi-link device (STA MLD) may perform seamless roaming between access point multi-link devices (AP MLDs) within the same seamless mobility domain (SMD). During such intra-SMD roaming events, the STA MLD may continue active uplink and downlink data sessions without disconnection. To maintain such continuous data transfer during the transition, context information such as sequence numbers (SNs), buffer state, and delivery progress of media access control (MAC) protocol data units (MPDUs) is coordinated between the serving and target AP MLDs. Without such coordination, issues like data loss or duplication may arise and compromise the overall network performance.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example of client roaming within a seamless mobility domain (SMD), according to some embodiments of the present disclosure.

FIG. 2A depicts an example signaling flow for the roaming preparation phase, according to some embodiments of the present disclosure.

FIG. 2B depicts an example signaling flow for the roaming execution phase, according to some embodiments of the present disclosure.

FIG. 3A depicts an example of downlink context transfer for seamless roaming using a single receive (Rx) reorder buffer, according to some embodiments of the present disclosure.

FIG. 3B depicts an example of downlink context transfer with SN gap handling for seamless roaming using a single Rx reorder buffer, according to some embodiments of the present disclosure.

FIG. 4A depicts an example of downlink context transfer without sequence number (SN) coordination using separate Rx reorder buffers, according to some embodiments of the present disclosure.

FIG. 4B depicts an example of downlink context transfer with SN coordination using separate Rx reorder buffers, according to some embodiments of the present disclosure.

FIG. 5 depicts an example of uplink context transfer for seamless roaming using a single transmit (Tx) buffer, according to some embodiments of the present disclosure.

FIG. 6A depicts an example of uplink context transfer with hole reporting and out-of-order delivery, according to some embodiments of the present disclosure.

FIG. 6B depicts an example of uplink context transfer with hole reporting and in-order delivery, according to some embodiments of the present disclosure.

FIG. 6C depicts an example of uplink context transfer with hole reporting and timeout-based delivery, according to some embodiments of the present disclosure.

FIG. 7 depicts an example of unlink context transfer for seamless roaming using separate transmit (Tx) buffers, according to some embodiments of the present disclosure.

FIG. 8 depicts an example method for a serving AP to perform downlink context transfer during seamless roaming, according to some embodiments of the present disclosure.

FIG. 9 depicts an example method for a target AP to process downlink context and resume transmission during seamless roaming, according to some embodiments of the present discourse.

FIG. 10 depicts an example method for a serving AP to perform uplink context transfer during seamless roaming, according to some embodiments of the present disclosure.

FIG. 11 depicts an example method for a target AP to process uplink context and resume transmission during seamless roaming, according to some embodiments of the present discourse.

FIG. 12 is a flow diagram depicting an example method for downlink context transfer, according to some embodiments of the present disclosure.

FIG. 13 is a flow diagram depicting an example method for uplink context transfer, according to some embodiments of the present disclosure.

FIG. 14 depicts an example network device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### OVERVIEW

One embodiment presented in this disclosure provides a method, including transmitting, by a serving access point (AP), a sequence of downlink data units for a traffic identifier (TID) to a client device, the sequence of downlink data units having sequence numbers falling within a transmit window for the TID, receiving, by the serving AP and from the client device, a roaming request identifying a target AP, and in response to receiving the roaming request, sending, by the serving AP, a roaming context message to the target AP, the roaming context message comprising at least one of: a starting sequence number (SSN) of the transmit window corresponding to the TID, or a next sequence number (NSN) for the TID, where the NSN is a first sequence number to be assigned for downlink data units of the TID transmitted by the target AP to the client device.

One embodiment presented in this disclosure provides a method, including receiving, by a serving access point (AP), a sequence of uplink data units for a traffic identifier (TID) from a client device, the sequence of uplink data units having sequence numbers falling within a receive window for the TID, receiving, by the serving AP and from the client device, a roaming request identifying a target AP, and in response to receiving the roaming request, sending, by the serving AP, a roaming context message to the target AP, the roaming context message comprising at least one of a last sequence number (LSN) for the TID, where the LSN corresponds to a sequence number of a last uplink data unit that the serving AP has passed to a distribution system (DS) for the TID, or a next sequence number (NSN) for the TID, where the NSN corresponds to a sequence number of a first uplink data unit to be passed to the DS by that the target AP expects to receive from the client device for the TID.

Other embodiments in this disclosure provide one or more non-transitory computer-readable media containing, in any combination, computer program code that, when executed by operation of a computer system, performs operations in accordance with one or more of the above methods, as well as a system of a network device comprising one or more computer processors, and one or more memories collectively containing one or more programs, which, when executed by the one or more computer processors, perform operations in accordance with one or more of the above methods.

### EXAMPLE EMBODIMENTS

In scenarios where a station multi-link device (STA MLD) roams across access point multi-link devices (AP MLDs) within the same seamless mobility domain (SMD), active uplink (UL) and downlink (DL) data transfers are expected to continue without interruption. To maintain such continuous and smooth data exchange, context information such as sequence number (SN) state, buffer occupancy, and media access control (MAC) protocol data unit (MPDU) delivery status can be coordinated between the serving and target AP MLDs. Without such coordination, problems such as data loss or duplication may occur, which may compromise the overall network performance.

The presence of holes in either the UL or DL transmission state during the STA’s association with the serving AP further complicates the roaming process. For example, during UL transmission under a block acknowledgement (BA) agreement, the STA may have sent multiple MPDUs to the serving AP, some of which are lost due to wireless errors or collisions. The missing MPDUs may leave holes in the serving AP’s receive (Rx) BA scoreboard. As used herein, the STA’s transmit (Tx) BA scoreboard refers to the STA’s record of transmitted UL MPDUs and their acknowledgement status, and the AP’s Rx BA scoreboard refers to the AP’s record of correctly received and acknowledged DL MPDUs based on sequence numbers within the negotiated BA window.

When the STA initiates a roaming procedure, a challenge arises in determining how the serving AP should treat the UL MPDUs corresponding to SNs after these holes, such as whether to flush them to the distribution system (DS), drop them entirely, or instruct the target AP to transfer them to the DS. Additionally, in cases where the AP’s BA response was not received by the STA, the STA’s Tx scoreboard may be out of synchronization with the serving AP’s Rx scoreboard, which adds complexity to duplicate and hole management. Similar coordination issues and hole conditions may also arise in the DL direction, where the AP’s Tx scoreboard may contain holes due to missing or delayed DL MPDUs from the DS, which further complicate in-order delivery and buffer alignment during the roaming transition.

To address these challenges (and other relevant concerns) and preserve ongoing traffic flows across roaming, it would be beneficial to define signaling and context transfer mechanisms that enable coordination of data delivery across serving and target AP MLDs. The present disclosure introduces such context signaling mechanisms for both DL and UL directions, including options for sequence number (SN) coordination, data flushing, and buffer state reporting between the serving and target AP MLDs.

More specifically, in one embodiment where DL data transfer continues during roaming, the serving AP MLD determines and transfers, to the target AP MLD, information such as the current starting sequence number (SSN) (e.g., which corresponds to the start of the current BA window), and the next sequence number (NSN) to be used by the target AP. When SN holes exist (e.g., when the serving AP has missing or delayed MPDUs from the distribution system (DS)), the serving AP may additionally signal the last successful transmitted SN (LSN) and hole-related information using formats such as the SN of the first hole, a bitmap, or a range of missing SNs. Based on the configuration, the serving AP may flush all received MPDUs (e.g., allowing out-of-order delivery to the DS), flush only up to the first hole (e.g., to maintain in-order delivery), or instruct the target AP to initiate transmission after a timeout.

In another embodiment, for UL data transfer during roaming, the serving AP MLD may transfer context information to the target AP MLD. The context transfer allows the target AP MLD to initialize its Rx window and perform duplicate detection. When a BA agreement exists for a given TID, the serving AP may transfer a last sequence number (LSN) (e.g., which corresponds to the last MPDU that has been passed by the serving AP to the DS), or a next sequence number (NSN) (e.g., which corresponds to the first MPDU that the target AP MLD is expected to deliver to the DS). In cases where no BA agreement is established for a given TID, the serving AP may instead generate and transfer a receiver cache to the target AP MLD. As used herein, the receiver cache refers to a stored record of received MPDUs for a given TID, indicating whether each MPDU has already been processed (e.g., passed to the DS). The target AP may use the received cache to perform duplicate detection during roaming. When SN holes exist (e.g., when the serving AP has missing or delayed MPDUs from the STA), the serving AP may additionally transfer the SN of the first hole in its Rx BA scoreboard. The UL context transfer allows the target AP to correctly configure its Rx window. The serving AP may also indicate the SN of the first hole in its roaming response to the STA, or the STA may detect the hole based on identifying one or more MPDUs that were not acknowledged. Based on the detection, the STA may retransmit the MPDUs corresponding to and following the first hole to the target AP, which can then identify and manage their sequence for proper delivery. Depending on configuration or delivery policy, the serving AP may flush all received MPDUs to the DS (e.g., accepting out-of-order delivery), flush only up to the first hole (e.g., to preserve in-order delivery), or apply a timeout before the target AP forwarding the remaining MPDUs.

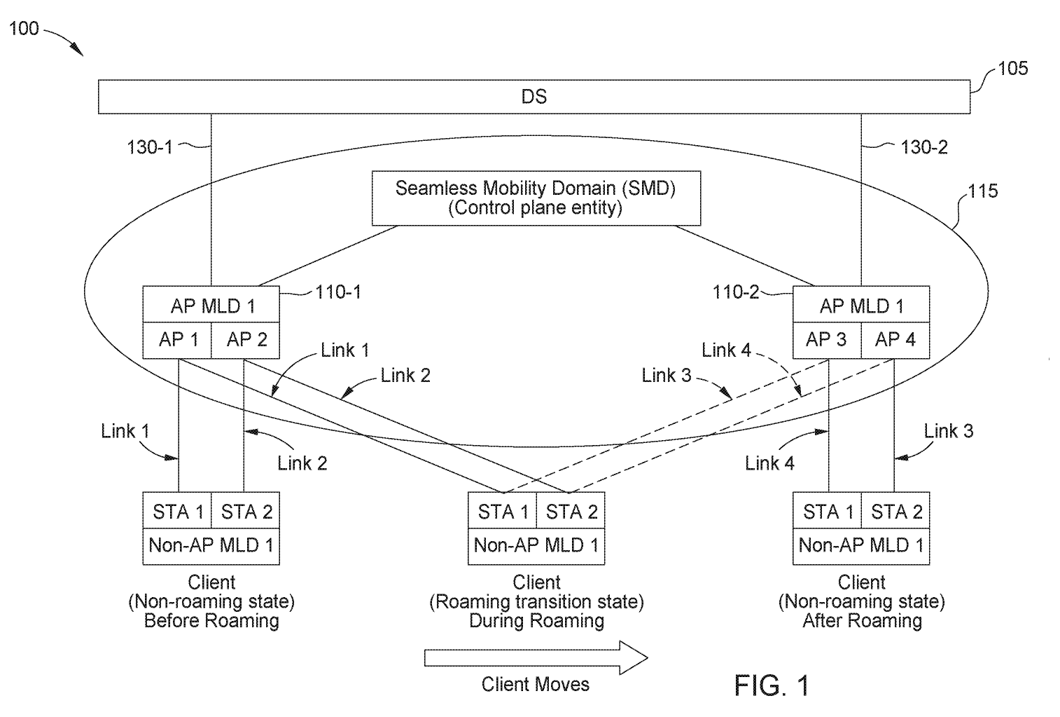

FIG. 1 depicts an example 100 of client roaming within a seamless mobility domain (SMD), according to some embodiments of the present disclosure.

In this example 100, two access point multi-link devices (AP MLDs) 110-1 and 110-2 are provided, each including two affiliated AP radios. Specifically, AP MLD 1 includes AP 1 and AP 2, and AP MLD 2 includes AP 3 and AP 4. Both AP 110-1 and 110-2 are part of the same seamless mobility domain (SMD) 115.

As used herein, a SMD refers to a logical control plane entity that enables seamless client roaming across multiple AP MLDs. One SMD may include all AP MLDs in an extended service set (ESS), or an ESS may be partitioned into multiple SMDs depending on network configuration and mobility policies. Each SMD is uniquely identified within the network by a virtual SMD media access control (MAC) address, and each AP MLD is statically configured with the SMD to which it belongs. Affiliated APs (e.g., AP 1 or AP 2) of each AP MLD advertise the associated SMD information in management frames such as beacons and probe responses. Each AP MLD maintains its own MAC service access point (MAC SAP) interface to the distribution system (DS). As depicted, AP MLD 1 (110-1) connects to the DS 105 through MAC SAP 1 (130-1), and AP MLD 2 (110-2) connects to the DS 105 through MAC SAP 2 (130-2).

As depicted, the client device is a non-AP MLD 120-1, also referred to in some embodiments as a station multi-link device (STA MLD), which includes two affiliated radios, STA 1 and STA 2. To initiate communication within the SMD 115, the STA MLD 120-1 performs authentication and association procedures with AP MLD 1 (110-1) and therefore establishes two initial links: Link 1 and Link 2. As depicted, Link 1 connects STA 1 to AP 1, and Link 2 connects STA 2 to AP 2. The SMD 115 maintains control plan state for the client 120-1, including association information, security context, and capability parameters.

During roaming, the non-AP MLD 120-1 establishes new links with the target AP MLD 2 (110-2), forming Link 3 that connects STA 1 to AP 3 and Link 4 that connects STA 2 to AP 4. The intermediate state enables the client to maintain simultaneous connectivity with both the serving and target AP MLDs and achieves make-before-break roaming. More specifically, the non-AP MLD 120-1 maintains downlink (DL) wireless connectivity with both AP MLDs 110 to receive any buffered DL data from the serving AP MLD 110-1. For uplink (UL) traffic, the non-AP MLD 120-1 maintains connectivity with only one AP MLD 110 at a time, first with the source AP MLD 110-1 and then with the target AP MLD 110-2 after reassociation is completed.

Once the transition is complete, the non-AP MLD 120-1 disassociates from AP MLD 110-1 and removes Link 1 and Link 2. The non-AP MLD 120-1 maintains Link 3 and Link 4 for ongoing communication through AP MLD 2 (110-2).

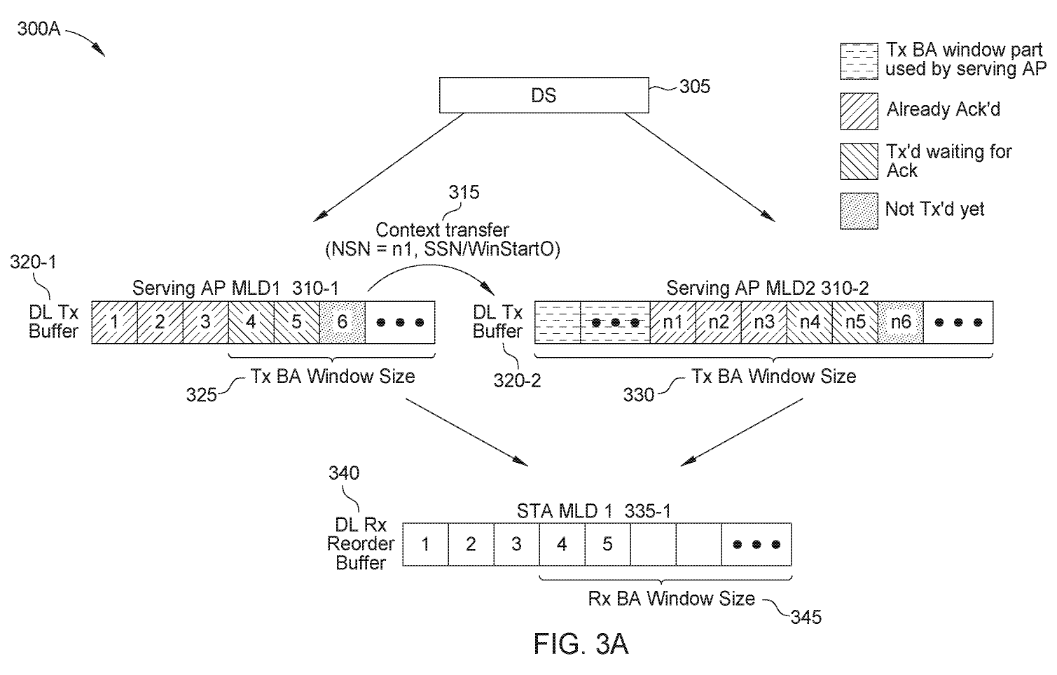

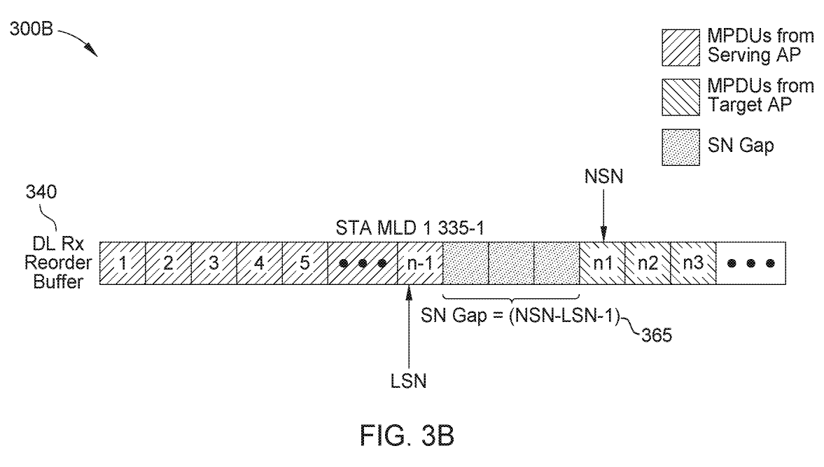

To support seamless roaming and preserve continuity of active data sessions, context information maintained by the SMD 115 for the client 120-1 may be transferred from the serving AP MLD 110-1 to the target AP MLD 110-2. This includes not only control-plane state (e.g., association and security parameters), but also data-plane context provided for uninterrupted UL and DL transmissions. More specifically, context such as sequence number (SN) state, buffer status, and delivery history may be shared to enable the target AP MLD to resume data transmission and reception without causing duplication, reordering, or data loss. For example, in the DL direction, the serving AP MLD may transfer the current starting sequence number (SSN) of the transmit window and the next sequence number (NSN) to the target AP MLD 110-2 to maintain SN continuity at the STA MLD. Similarly, in the UL direction, the serving AP MLD 110-1 may provide the SN of the last MPDU forwarded to the DS, the SN of the first hole, or the receiver cache to the target AP MLD 110-2 for duplicate detection. More details about the context transfer in SMD are discussed below with references to FIGS. 3A-3B, 4A-4B, 5, 6A-6C AND 7.

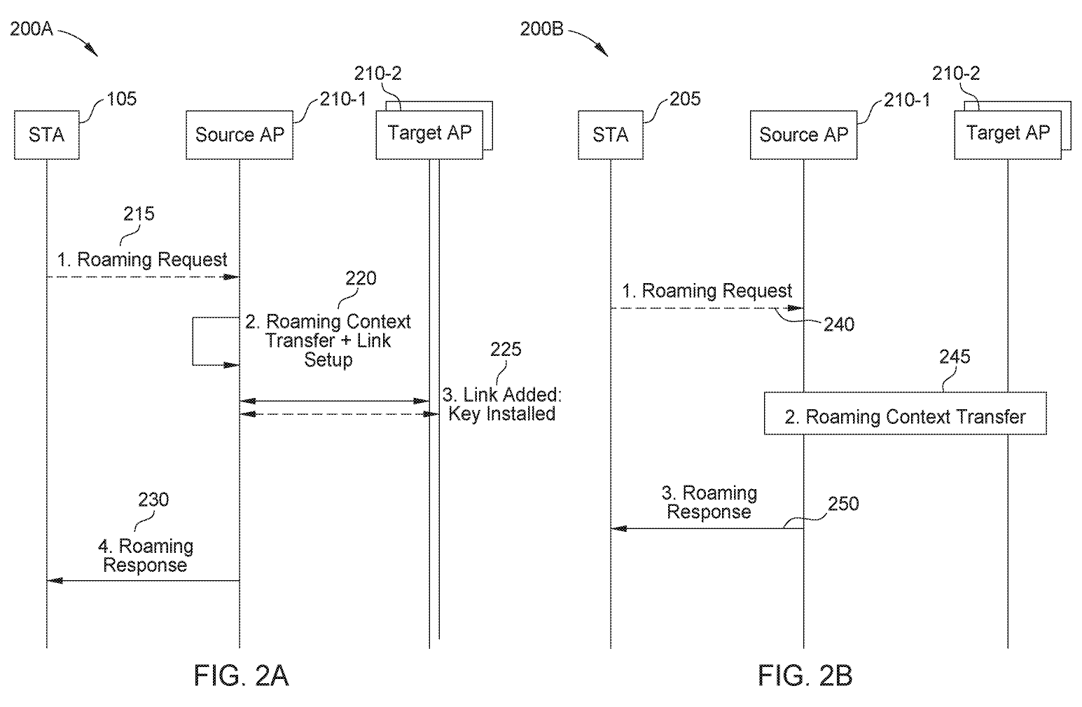

FIG. 2A depicts an example signaling flow 200A for the roaming preparation phase, according to some embodiments of the present disclosure. The STA 205 may correspond to non-AP MLD 120-1 as depicted in FIG. 1, the source AP 210-1 may correspond to AP MLD 110-1 as depicted in FIG. 1, and the target APs may correspond to AP MLD 110-2 as depicted in FIG. 1. The source AP 210-1 and target APs belong to the same SMD.

When a STA 205 roams to another AP 210-2 within the same SMD, the roaming process includes two logical phases: the roaming preparation phase and the roaming execution phase. In the preparation phase, as depicted in FIG. 2A, the network proactively prepares one or more neighboring AP MLDs for a potential roaming event, such as by transferring context information and link setup data from the serving (source) AP MLD 210-1 to the one or more target AP MLDs 210-2.

At step 215, the STA 205 sends a roaming request to the source AP 210-1, including a list of requested target AP MLDs. In another embodiment, the source AP 210-1 initiates the roaming preparation proactively without receiving a request from the STA 205 (e.g., for load balancing purposes). In this configuration, step 1 may be omitted.

At step 220, the source AP 210-1 evaluates the target AP MLDs based on current network state, roaming policies, or AP load conditions. Additionally, the source AP 210-1 determines the appropriate roaming context information and, in some embodiments, transmits the roaming context information to the target APs. In the context transfer message, as depicted, the source AP 210-1 includes link setup data and roaming-related context to the target APs over the DS. More detail about the context transfer is discussed below with reference to FIGS. 3A-3B, 4A-4B, 5, 6A-6C and 7.

At step 225, the target AP 210-2 completes preliminary setup procedures, including link addition and key installation.

At step 230, the source AP 210-1 sends a roaming response back to the STA 205. The roaming response provides the list of target AP MLDs that have been prepared for the potential roaming event.

FIG. 2B depicts an example signaling flow 200B for the roaming execution phase, which follows the earlier roaming preparation phase depicted in FIG. 2A. In this stage, the STA 205 initiates (or responds to) a transition process that completes the handover and enables seamless UL and DL data transfer continuity.

At step 240, the source AP 210-1 sends a roaming request to the target AP MLD. The request specifies the selected AP MLD the STA intends to connect.

At step 245, the source AP 210-1 reserves the necessary resource and performs dynamic context transfer to the target AP 210-3, including information needed for maintaining traffic continuity, such as sequence numbers (SN) for DL and UL flows, packet numbers (PN) for secure replay protection, and any other runtime MAC-layer state relevant to support uninterrupted delivery. As depicted in FIGS. 2A and 2B, the context transfer may occur during the roaming preparation phase, the execution phase, or across both phases, depending on deployment design and system capability. More detailed techniques for dynamic context transfer, including SN coordination and buffer status and delivery control, are discussed below with reference to FIGS. 3A-3B, 4A-4B, 5, 6A-6C and 7.

At step 250, the source AP 210-1 returns a roaming response to the STA MLD, which includes the group encryption keys and the association identifier (AID) needed for completing link setup with the target AP 210-3. Through the execution phase, the STA can maintain uninterrupted communication even as it transitions between AP MLDs.

As used herein, the roaming request serves as a generic term for any frame that initiates the roaming of a non-AP MLD from a serving AP MLD to a target AP MLD. The roaming request may include an Add Link Response transmitted using the existing Link Reconfiguration Request frame, an enhanced variant of the Link Reconfiguration Request frame, a new management/action frame, or even an existing standardized management frame adapted to carry roaming-related information. As used herein, the roaming response is a generic term referring to any response frame issued by the source AP MLD that includes context required for the STA MLD to proceed with roaming. The roaming response may include, for example, an Add Link Response transmitted using the existing Link Reconfiguration Response frame, an enhanced variant of the Link Reconfiguration Response frame, a new management/action frame, or an existing standardized management frame adapted to convey roaming-related information.

FIG. 3A depicts an example 300A of downlink context transfer for seamless roaming using a single receive (Rx) reorder buffer, according to some embodiments of the present disclosure. The depicted context transfer can occur during the roaming preparation phase or during the roaming execution phase (as depicted in FIG. 2A and 2B), in an embodiment where a client device maintains a single Rx reorder buffer that is shared across both the serving and target AP MLDs. The STA’s configuration enables the sequence numbers (SNs) to be used in a continuous and increasing order, and therefore allows the existing block acknowledgement (BA) agreement for a traffic identifier (TID) to be reused during and after roaming.

The DS 305 corresponds to the DS 105 as depicted in FIG. 1, the serving AP MLD 1 (310-1) corresponds to AP MLD 1 (110-1) as depicted in FIG. 1, and the target AP MLD 2 (310-2) corresponds to AP MLD 2 (110-2) as depicted in FIG. 1. Both AP MLDs are part of the same SMD and connect to the DS through independent MAC SAPs. In addition, the STA MLD 1 (335-1) corresponds to non-AP MLD 1 (120-1) as depicted in FIG. 1.

As depicted, the STA MLD 1 (335-1) initially connects to the serving AP MLD 1 (310-1) and establishes active DL connectivity. The AP MLD 1 (335-1) maintains a DL transmit (Tx) buffer 320-1 that includes MPDUs with sequence numbers 1 through 3, which have already been transmitted and acknowledged by the STA MLD 1 (335-1). Some MPDUs with SNs 4 and higher remain in the DL Tx buffer. These MPDUs have been transmitted to the client device but have not yet been acknowledged. The serving AP MLD maintains a Tx BA window 325. The start of the Tx BA Window 325 (also referred to as the WinStartO, where O stands for originator) corresponds to the sequence number of the first unacknowledged MPDU in the DL Tx buffer. The size of the Tx BA Window (also referred to as the WinSizeO, where O stands for originator) is determined based on the buffer size negotiated as part of the BA agreement with the client device. The Tx BA Window size negotiated per BA agreement can be 64, 128, 256, 512, or 1024.

The Tx BA window 325 defines the set of sequence numbers that can be assigned to DL MPDUs without acknowledgement being received, including the set of one or more sequence numbers assigned to outstanding MPDUs for which acknowledgements are expected, as well as sequence numbers that can be assigned to future MPDUs to be transmitted to the client. On the STA side, the DL Rx reorder buffer 340 (where Rx stands for Receive) temporarily holds received MPDUs before these are transmitted to the upper layer on the client, and the associated Rx BA window 345 defines the range for expected sequence numbers for MPDUs for in-order delivery to the upper layer. The size of the Tx BA window 325 of AP MLD 1 may be aligned with the size of Rx BA window 345 of the STA MLD 1. Such alignment allows proper SN coordination between the two buffers as governed by the BA agreement established between the serving AP MLD and the client.

As shown in FIG. 3A, the STA MLD 1 (335-1) roams to the target AP MLD 2 (310-2), which takes over the DL transmission responsibility. To do so, AP MLD 2 (310-2) maintains its own DL Tx buffer 320-2 to begin queuing data received from the DS 305 for delivery to the client 335-1. During the roaming transition, problems such as packet loss, duplicate delivery, or reordering violations may arise if DL context is not properly handed over to the target AP MLD. To ensure seamless and smooth data transmission during roaming transition, DL SN coordination is performed via context transfer 315 from the serving AP MLD to the target AP MLD.

As depicted, the DL context transfer 315 includes two parameters: the starting sequence number (SSN) (also referred to as WinStartO, where O refers to originator) and the next sequence number (NSN). As used herein, the SSN refers to the beginning of the current DL Tx BA window at the serving AP MLD at the time of context transfer. The DL Tx BA window typically has three parameters maintained: the start of the window (WinStartO), the size of the window (also referred to as WinSizeO, where O refers to originator), and the end of the window (also referred to as WinEndO, where O refers to originator). The end of the window is determined as WinEndO = (WinStartO + WinSizeO 1). The size of the Tx BA Window is determined based on the buffer size negotiated as part of the BA agreement with the client device. The SSN is provided to inform the target AP MLD 320-2 of the receive reorder buffer window currently maintained by the STA MLD 1 (335-1). The SSN allows the target AP MLD 310-2 to understand the lower bound of the STA’s Rx buffer window and ensures it does not transmit MPDUs with sequence numbers that fall outside of the window range. Otherwise, any such transmitted MPDUs could be dropped or rejected by the STA. In this example, SSN=4 is transmitted, indicating that SN 4 is the first unacknowledged MPDU still pending at the serving AP MLD 310-1. The WinSizeO of the DL Tx BA Window at the serving AP MLD is also transferred to the target AP MLD as part of BA agreement context transfer.

The NSN, as used herein, refers to the sequence number of the first DL MPDU that the target AP MLD 310-2 is expected to transmit to the STA MLD. In this example 300A, NSN =n1 is transferred. The NSN can typically fall within the Tx BA window size (e.g., in example 300A, the NSN may be 50, falling within the Tx BA window size of 128) and this can allow simultaneous transmission of DL data units from both the serving AP MLD and the target AP MLD to the client device, achieving faster data transfer during roaming transition. In this case, the Tx BA Window is split between the serving AP MLD and the target AP MLD, allowing both the serving AP and the target AP to transmit DL data units. Specifically, a portion of the SN space of the TX BA window is used by the serving AP MLD, and the remaining SN space of the Tx BA window is used by the target AP MLD. The target AP MLD maintains its own Tx BA Window for the TID (associated with the client device) with the SSN set to the WinStartO for the window (as shown by 330-1) and WinSizeO determined based on the buffer size in the BA agreement received from the serving AP MLD (e.g., a buffer size of 128).

In some embodiments, the NSN and SSN are transmitted for each of one or more TIDs, on a per-TID basis. In embodiments where the DL data units associated with multiple TIDs, such as when the serving AP MLD or target AP MLD maintains separate contexts for different TIDs, the SSN and NSN may be independently determined and signaled for each TID based on the state of its corresponding transmit buffer and acknowledgement status.

Although shown in 300A, in one embodiment, the NSN may fall outside the current DL Tx BA window 325 of the serving AP MLD 310-1, which may allow more time at the target AP for DL Tx during roaming transition. In such configurations, the STA’s Rx reorder buffer 340 will not immediately expect frames from the target AP 310-2, and the target AP 310-2 has flexibility in timing its first transmission. The target AP MLD transmits DL data frames to the client when it receives indication from the client that the client is out of power save mode on one or more of the setup links with the target AP MLD.

In some embodiments, the NSN sent to the target AP MLD may intentionally fall beyond the last SN already assigned by the serving AP MLD at the time of sending the context to the target AP MLD, introducing a gap. Such a design allows the system to leave a buffer margin of sequence numbers between the serving and target AP MLDs at the time of context transfer, accounting for the possibility that additional MPDUs may still be arriving from the DS 305 to the serving AP 310-1 before the DS mapping is fully redirected to the target AP MLD (which results in MPDUs getting delivered by the DS to the target AP MLD for the client).

Upon receiving the SSN and NSN as part of the context transfer 315, as depicted, the target AP MLD 2 (310-2) initializes its Tx buffer 320-2 and sets up its Tx BA window 330. The target AP MLD sets the SSN to be the WinStartO for its Tx BA window (as shown by 330-1). The size of the window (WinSizeO) is determined based on the buffer size in the BA agreement received from the serving AP MLD (such as 128 buffer size). The target AP MLD 2 (310-2) begins buffering new MPDUs from the DS, assigning sequence numbers to MPDUs starting at SN = n1, and withholds DL data units transmission to the STA until it is safe to transmit based on the STA’s Rx window progression. Specifically, the target AP uses SSN and WinSizeO as a reference to estimate when the STA will be ready to accept MPDUs starting at NSN = n1. This evaluation can avoid premature transmission that could fall outside the STA’s Rx BA window 345.

The disclosed mechanism supports a seamless handover with in-order delivery when the STA maintains a single Rx reorder buffer across the roaming transition. The mechanism also reduces control complexity for both the AP and STA MLDs, as it preserves SN alignment/continuity from the serving AP MLD to the target AP MLD and avoids the need for buffer reset or BA renegotiation during the roaming transition.

FIG. 3B depicts an example 300B of downlink context transfer with SN gap handling for seamless roaming using a single Rx reorder buffer, according to some embodiments of the present disclosure.

In the DL Rx reorder buffer 340 of the STA MLD, MPDUs with SNs from 1 to (n1-4) are transmitted by the serving AP MLD 310-1, and MPDUs with SNs starting from (or beginning with) n1 are transmitted by the target AP MLD 310-2. The last SN that is successfully transmitted by the serving AP MLD is LSN and is (n1-4) as depicted in FIG. 3B, and the next SN (or the first SN) to be used by the target AP is NSN = n1. Since the LSN corresponds to the SN of the last MPDU transmitted by the serving AP MLD, the serving AP MLD would not transmit any other MPDUs with SN lower that NSN (n1). Thus, the set of sequence numbers in the SN gap 365 between LSN and NSN (e.g., SN gap = NSN – LSN – 1) represents a set of SNs that account for extra SN buffer space that does not get used by the serving AP MLD. In 300B, the SNs n1-3, n1-2, and n1-1 correspond to the SN gap 365.

In some embodiments, the serving AP MLD signals both the NSN and LSN to the STA MLD in a roaming response (e.g., in the roaming response during roaming preparation or roaming execution as depicted in FIG. 2A-2B). The NSN indicates the first SN that the target AP MLD will use for transmission, and the LSN indicates the last SN that would be transmitted by the serving AP. The LSN indicated in the roaming response may be an estimated value for LSN, which may later be revised in a follow-up signaling from the serving AP MLD to the client. The LSN value may be explicitly signaled, or implicitly conveyed via an empty buffer indication or no more data from the serving AP. The serving AP may also indicate termination of DL data to the STA MLD (for one or more TIDs) and this provides an indication that no more DL MPDUs would be received for the corresponding TID(s). Upon receiving the LSN information or indication of termination of DL data from the serving AP MLD, the STA MLD may stop waiting for MPDUs with SNs in the range [LSN+1, NSN-1], and the STA MLD advances its Rx reorder BA window accordingly. Specifically, the STA MLD advances the start of its Rx reorder BA window (also referred to as WinStartB, where B stands for receive buffer) to be at least NSN and stops waiting for any MPDUs with SN lower than NSN. This helps to avoid delivery delays or reorder buffer blockage at the STA MLD, since, without knowledge of the LSN, the client device may conservatively continue waiting for MPDUs with the SNs in the range [LSN+1, NSN-1] even though those MPDUs will not be transmitted, and the STA MLD may advance its Rx reorder window after a much longer timeout value. In some embodiments, the LSN is transmitted for each of one or more TIDs, on a per-TID basis.

In some embodiments, the roaming request further comprises an indication for the serving AP MLD to include the DL context transfer in the roaming request, and the context transfer includes at least one of the NSN or the LSN. By receiving the SN context, the client device is able to identify the boundary of the DL data responsibility between the serving AP MLD and the target AP MLD, and accordingly manage the receive-side reordering behavior.

The serving AP may provide the LSN to the client device using various mechanisms. In some embodiments, the LSN may be directly included in the roaming response as an explicit field. In some embodiments, the LSN may be conveyed through a separate management frame or a control frame transmitted by the serving AP MLD. In some embodiments, the LSN may be signaled in-band within a DL data frame, eliminating the need for additional management overhead.

When the LSN is signaled in-band, several options are available for embedding the relevant information within a downlink data transmission. For example, the LSN may be included in the A-Control field of a quality of service (QoS) Null data frame, allowing the client to interpret the frame as a boundary marker without containing any actual payload. In some embodiments, the LSN may be signaled in the A-Control field of the media access control (MAC) header of a QoS data frame. In some cases, the LSN may be implicitly conveyed by indicating an empty buffer status for the corresponding TID within the A-Control field or another field in the MAC header. In such embodiments, the client may infer that the sequence number of that downlink frame represents the LSN. Similarly, a no-more-data indication for the TID may be included in the MAC header, again implying that the SN of the frame serves as the LSN.

In addition to informing the STA, the serving AP MLD may also transfer the LSN to the target AP MLD as part of the DL context transfer (e.g., along with SSN and NSN). The serving AP MLD may transfer an estimated value of LSN to the target AP MLD along with SSN and NSN. In some embodiments, the serving AP may transfer LSN later to the target AP MLD when the serving AP MLD transmits its last DL data unit to the STA MLD with LSN. This LSN information allows the target AP MLD to safely expand its Tx BA window to the full negotiated BA window size without risking SN overlap with previously used transmission range.

In some embodiments, the target AP MLD may use the received LSN to determine the appropriate starting point for its Tx BA window. Specifically, the target AP may advance the start of its Tx window to the highest SN among the NSN or the SNs corresponding to the DL data units already transmitted and acknowledged for the corresponding TID.

In some embodiments, instead of receiving the LSN directly, the STA MLD signals to the target AP MLD that it has completed DL data retrieval from the serving AP. Such an indication enables the target AP to expand its Tx BA window to the full window size, even in the absence of an explicitly transferred LSN. Therefore, the indication of LSN supports efficient resumption of DL data transmission.

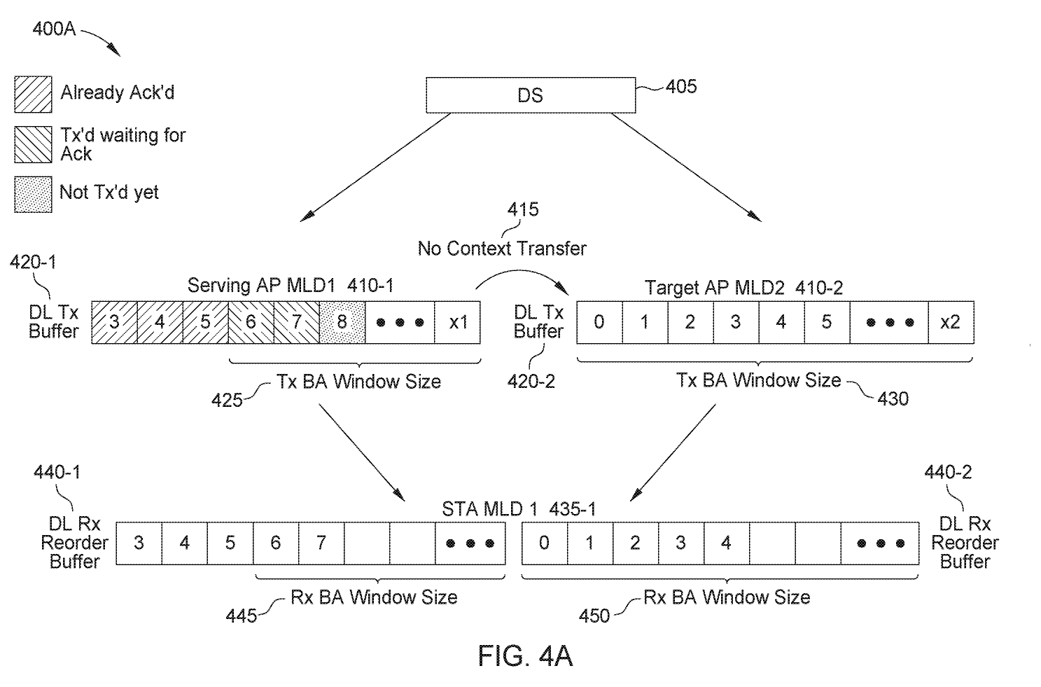

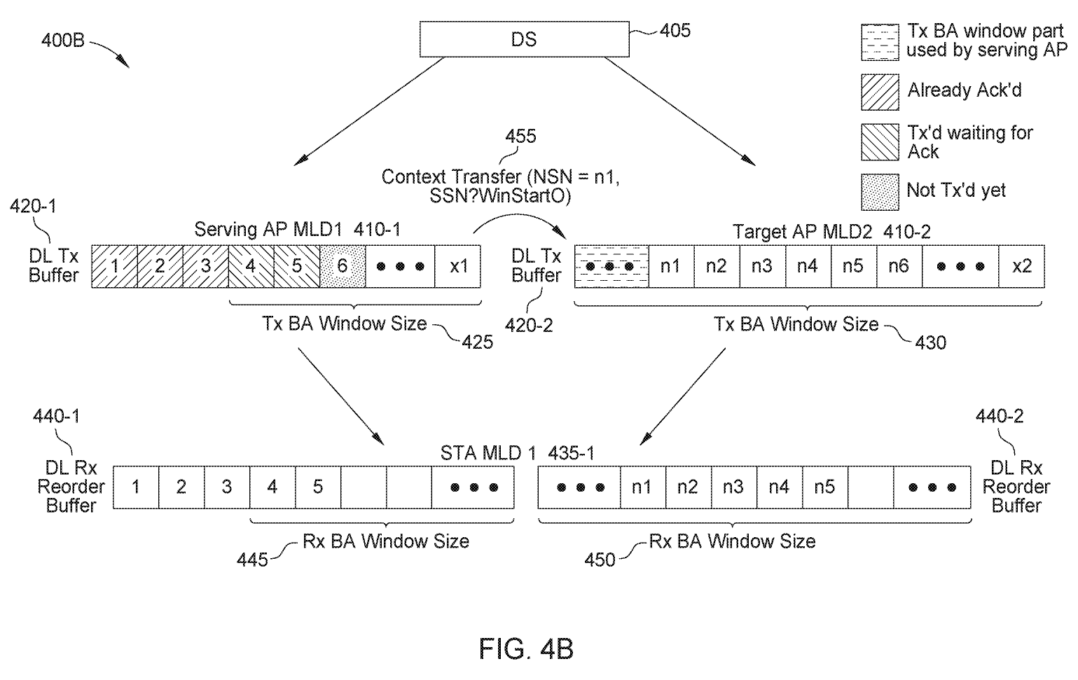

FIG. 4A depicts an example 400A of downlink context transfer without sequence number (SN) coordination between serving AP MLD and target AP MLD, using separate Rx reorder buffers at the STA MLD, according to some embodiments of the present disclosure.

In the example 400A, the STA MLD 1 (435-1) maintains separate DL Rx reorder buffers for each AP MLD, as shown by DL Rx reorder buffer 440-1 for the serving AP and DL Rx reorder buffer 440-2 for the target AP. This is in contrast to FIGS. 3A and 3B, where a single, shared Rx reorder buffer is maintained across serving and target APs to support SN continuity. Because the buffers are allocated separately for each AP, the Rx BA window and corresponding SN space used for the Rx BA window are managed independently. As a result, when the STA MLD roams from the serving AP MLD 1 (410-1) to the target AP MLD 2 (410-2), the SN state for the Rx BA window with the target AP MLD is reset (e.g., to zero). The target AP MLD initiates the SN counter for its transmit BA window to zero (or another known value).

The serving AP MLD 1 (410-1) transmits DL data to the STA MLD 435-1 using a DL Tx buffer 420-1. As shown, the Tx buffer contains MPDUs that are being transmitted to the STA MLD. MPDUs with SNs 3 to 5 have been transmitted and acknowledged by the STA MLD, MPDUs with SNs 6 and 7 are transmitted and waiting for acknowledgement from the STA MLD, and MPDU with SN 8 is buffered but not transmitted yet. The Tx BA Window 425 includes SNs starting from the SN of the first unacknowledged MPDU (in this case SN 6) and other SNs through x1. At the STA MLD, the received MPDUs from serving AP MLD1 are received and stored in the DL Rx reorder buffer 440-1, where the Rx BA window size 415 is negotiated as part of the block acknowledgment agreement between the STA MLD and the serving AP MLD.

The STA MLD 1 (435-1) then roams to target AP MLD 2 (410-2). However, in this embodiment, because the STA maintains two separate Rx reorder buffers (e.g., one for each AP MLD), the STA explicitly requests that the serving AP MLD 1 (410-1) not transfer any sequence number context information, such as the NSN (e.g., NSN = n1) or SSN (also referred to in some embodiments as WinStartO), to the target AP MLD 2 (410-2). As a result, the target AP MLD 2 (410-2) does not have any knowledge of the prior sequence numbers used for DL data transmitted to the STA for the TID. Instead, the target AP MLD 2 (410-2) initiates a fresh SN counter for the Tx BA window for the STA MLD for the TID. However, the Tx BA Window size at the target AP MLD is still based on the negotiated BA buffer size between the STA MLD and the serving AP MLD established as part of block acknowledgment (or, in some embodiments, a new BA agreement can be renegotiated). This negotiated BA buffer size is transferred from the serving AP MLD to the target AP MLD, for the target AP MLD to determine the Tx BA window size.

As depicted, the target AP MLD 2 (410-2) resets the starting SN counter for the Tx BA window 430. In the Tx buffer 420-2, the MPDUs are assigned SNs starting with the sequence number 0. Correspondingly, the STA MLD establishes a new DL Rx reorder buffer 440-2 with a separate Rx BA window 450. DL MAC Service Data Unit (MSDUs) from the DS 405 are delivered to the target AP, which maps them into MPDUs which are assigned SNs starting at 0.

Since SN spaces are independently maintained at the serving and target AP MLDs, any MPDUs that are already tried for delivery to the STA MLD by the serving AP MLD but are not acknowledged should not be forwarded to the target AP MLD for delivery to the STA MLD. This is because it may result in duplicate delivery to the upper layer at the STA MLD for the same MSDU, where the MSDU is delivered twice to the upper layer, once after it was received from the serving AP MLD and again after it was received from the target AP MLD.

In some embodiments, such configurations may lead to some data loss. For example, if an MPDU corresponding to SN=6 was transmitted by the serving AP MLD but got lost over the air and therefore never received by the STA MLD, then such data loss may not be recovered. This is because in such a configuration, because no SN context transfer is performed, the serving AP 410-1 may not be able to forward an MPDU that was not successfully delivered to the STA MLD, to the target AP 410-2 for delivery to the STA MLD, since that can lead to duplicate delivery of the same MPDU to the STA MLD. As a result, the target AP MLD may transmit only the MPDUs it receives from the DS, and the MPDU with SN=6 is permanently lost. This behavior may be acceptable for certain traffic types that can tolerate occasional loss. Such data loss can be avoided by another embodiment covered in FIG. 4B.

The embodiment in FIG. 4A reduces coordination complexity at the AP side by eliminating the need for SN coordination or reorder buffer synchronization. While it introduces the overhead of duplicated Rx buffer management at the STA and independent SN tracking at the AP, the disclosed embodiment avoids the complexities of SN context negotiation.

FIG. 4B depicts an example 400B of downlink context transfer with SN coordination using separate Rx reorder buffers, according to some embodiments of the present disclosure.

In this example 400B, the STA MLD 1 (435-1) maintains separate DL Rx reorder buffers 440-1 and 440-2 for the serving and target APs, similar to the embodiment shown in FIG. 4A, but with SN coordination preserved across the roaming between the serving AP MLD and the target AP MLD. This embodiment differs from non-coordinated cases (as depicted in FIG. 4A) by allowing DL SN context transfer (e.g., NSN, SSN) to the target AP MLD and the target AP MLD 2 (410-2) to continue using SNs in the same SN space as the serving AP MLD 1 (410-1).

As shown, the serving AP MLD 1 (410-1) transmits downlink MPDUs using a Tx buffer 420-1, with SNs up to SN=x1, and these MPDUs get stored in the Rx reorder buffer 440-1 of the STA MLD 1 (435-1). Upon roaming, the target AP MLD 2 (410-2) initiates DL communication using a separate Tx buffer 420-2 and Tx BA window 430, which continues from the SN used by the serving AP. As depicted, the DL context transfer 455 includes NSN (e.g., NSN=n1) and SSN (also referred to as WinStartO) (e.g., SSN=4) of the Tx BA window.

In this embodiment, while a new Rx buffer 440-2 is allocated to track reception from the target AP MLD, the target AP does not restart its SN counter for the DL Tx BA window to zero. Instead, the target AP preserves continuity across the transition and starts with SN=n1 based on the DL context transfer 455 when assigning SNs to the DL MPDUs. This is in contrast to the embodiment in FIG. 4A, where SNs were restarted from zero at the target AP.

With the DL context transfer 455, the target AP MLD 2 (410-2) knows where to resume transmission (e.g., based on the NSN) and ensures that it does not transmit MPDUs beyond the client’s Rx BA window (e.g., guided by the SSN). Although the STA MLD 1 (435-1) maintains separate reorder buffers 440-1 and 440-2 for the serving and target APs, SN continuity between the two APs does not create issues. This is because the STA MLD will process and forward all MPDUs from the first (serving) buffer 420-1 to the upper layer, before forwarding MPDUs from the second (target) buffer 420-2 to the upper layer. The ordering behavior preserves DL data ordering across the roaming transition. In this case, an MPDU that was not successfully delivered to the STA MLD (e.g. MPDU with SN=4) at the serving AP MLD can be forwarded to the target AP MLD for delivery to the STA MLD. Since SN continuity is maintained, that same MPDU can be delivered to the STA MLD by the target AP MLD e.g. with the SN assigned by the serving AP MLD (SN=4). The STA MLD will receive the MPDU from the target AP MLD and deliver it to the upper layer following the SN ordering and will not deliver the MPDU to the upper layer if Rx Reorder Buffer 1 (410-1) had delivered an MPDU with that SN from the serving AP MLD, avoiding duplicate delivery. Thus, such a configuration is useful to further avoid/minimize data loss and avoid duplicate delivery to the upper layer for DL data at the STA MLD.

This embodiment allows APs to support a unified SN coordination mode, even when the STA uses a separate per-AP reorder buffer model. Additionally, because DL SN context transfer is performed, the target AP MLD 2 (410-2) can continue seamlessly from the serving AP’s SN window, avoiding redundant transmission (e.g., guided by NSN) and supporting efficient transition (e.g., based on SSN). Compared to the embodiment shown in FIG. 4A, which resets the SN state, the current embodiment provides a simpler overall system design. This embodiment may be suitable for deployments where in-order delivery is desired but clients differ in how they manage buffer memory and reordering logic (e.g., some maintain a single Rx buffer across APs, whereas other clients use separate buffers per AP).

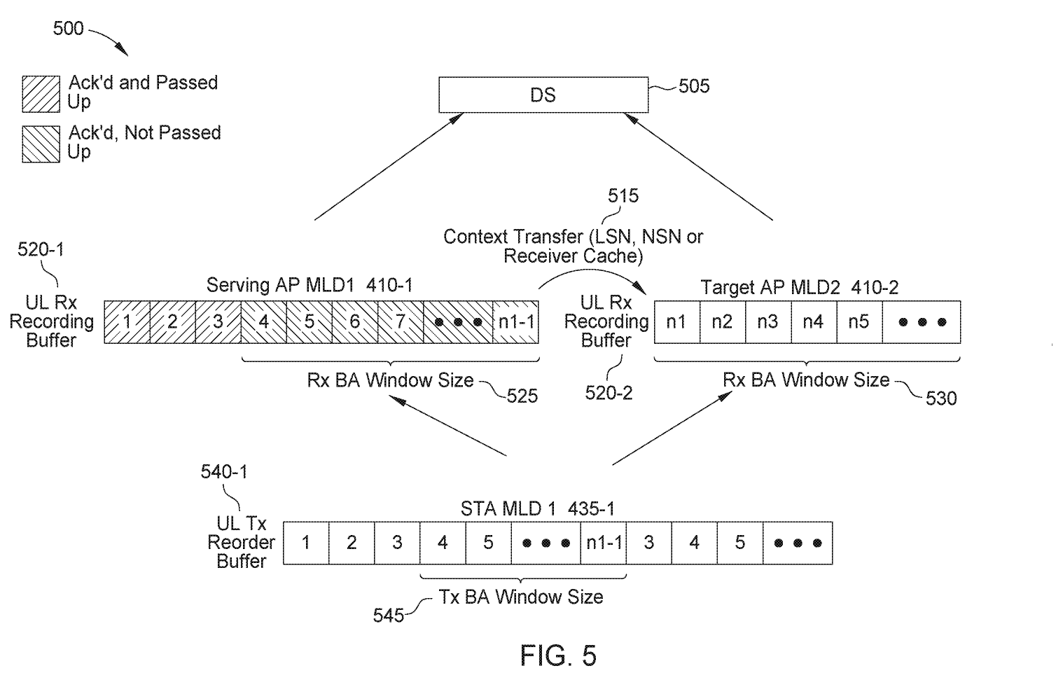

FIG. 5 depicts an example 500 of uplink context transfer for seamless roaming using a single transmit (Tx) buffer, according to some embodiments of the present disclosure.

In the example 500, the STA MLD 1 (535-1) maintains a single UL Tx buffer 540-1, even across roaming transition between APs. In uplink communication, MPDUs are transmitted from the STA MLD 1 (535-1) to the DS 505 via either the serving AP MLD 1 (510-1) or the target AP MLD 2 (510-2). The APs serve as intermediaries that receive the MPDUs from the STA, send block acknowledgement for the received MPDUs to the STA MLD, and then forward the acknowledged MPDUs to the DS 505.

In this embodiment, a unified UL Tx buffer is maintained, and therefore SN continuity can be preserved across the roaming boundary in uplink. More specifically, the STA MLD can assign SNs in a continuous and increasing order for UL MPDUs transmitted to the serving AP and the target AP. This also allows the BA agreement for a given TID to remain valid during and after roaming, eliminating the need for BA renegotiation or UL Tx buffer reinitialization or resetting of the SN for the MPDUs sent to the target AP.

As depicted, the serving AP MLD 1 (510-1) receives UL MPDUs into its UL Rx buffer 520-1, which is tracked by a Rx BA window 525. In this example, MPDUs with SNs 1-3 have been acknowledged and forwarded to the DS 505. MPDUs with SNs 4 through (n1-1) have been acknowledged by the AP but are still buffered in 520-1, waiting to be forwarded to the DS 505.

When the STA roams to target AP MLD 2 (510-2), after receiving a roaming request from the STA, the serving AP MLD first delivers already acknowledged UL data units to the DS from the receive reorder buffer. Then an UL context transfer 515 is performed to the target AP. The transfer includes the last SN (LSN) that has been forwarded to the DS by the serving AP. In the depicted example, after receiving the roaming request, the serving AP would deliver already acknowledged MPDUs from SNs 4 to (n1-1) to the DS. Then in the UL context transfer to the target AP, it sends LSN as (n1-1). The UL context transfer 515 may also include the NSN (in addition or in place of LSN), which indicates the first MPDU that the target AP is expected to receive from the STA MLD. In this example, the NSN is n1. The context information allows the target AP to avoid re-forwarding any already delivered MPDUs to the DS (thus avoiding duplicate delivery) and to safely resume data forwarding from the correct SN. The target AP MLD 2 begins receiving new UL MPDUs starting from SN=n1 into the UL Rx buffer 520-2 and manages the Rx BA window 530 to acknowledge and forward incoming data to the DS in sequence. In some embodiments, the LSN and NSN are transmitted for each of one or more TIDs, on a per-TID basis.

In embodiments where the UL data units associated with multiple TIDs, such as when the serving AP MLD or target AP MLD maintains separate contexts for different TIDs, the LSN and NSN may be independently determined and signaled for each TID based on the state of its corresponding receive buffer and acknowledgement status.

On the STA side, the UL Tx buffer 540-1 continues to hold MPDUs starting from SN = 1 through n1, n2, n3, and onward, tracked using the Tx BA window 545. As the UL MPDUs are acknowledged by the serving AP or the target AP, the start of the Tx BA window at the STA MLD moves forward. The size of the Tx BA window at the STA MLD is determined based on the UL BA agreement negotiated between the STA MLD and the AP MLD. Because a single Tx buffer is used at the STA MLD, the SN continuity is preserved, and retransmissions (if necessary) follow the same sequence numbering without requiring buffer reset or reinitialization.

In embodiments where no BA agreement is established (e.g., for unidirectional or lightweight flows) for a TID or management frames (MMPDUs), the serving AP may transfer its receiver cache instead of the SN state of the BA window to the target AP MLD. The receiver cache contains the record of previously received MPDUs (e.g., from 1 to x1) or the last SN received for a TID or for MMPDUs, which allows the target AP to perform duplicate detection for the TID (for which no UL BA agreement is setup) or management MPDUs and prevent redundant delivery to the DS 505.

As depicted, the UL Rx buffer 520-2 at the target AP receives MPDUs starting from SN=n1 onward, processes acknowledgments, and begins forwarding to the DS 505 without introducing duplication.

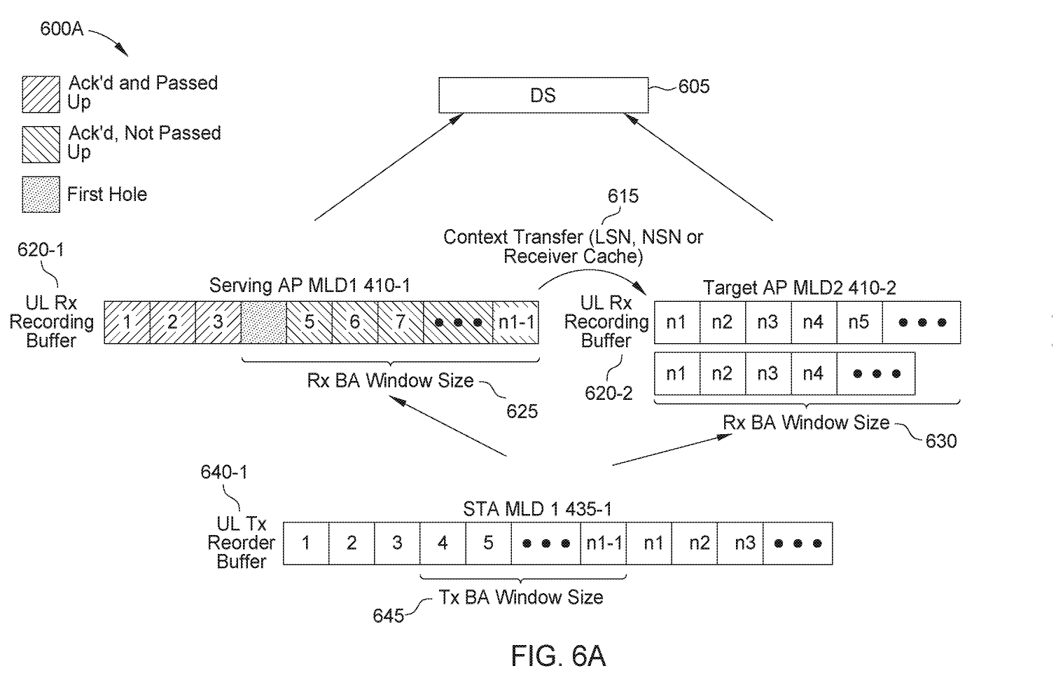

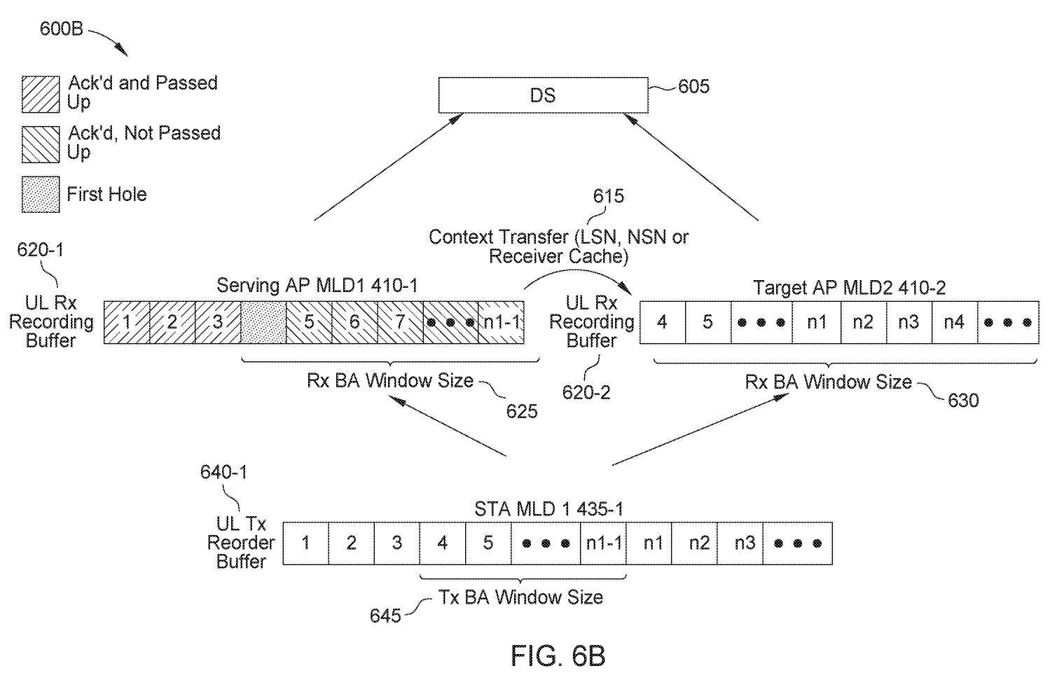

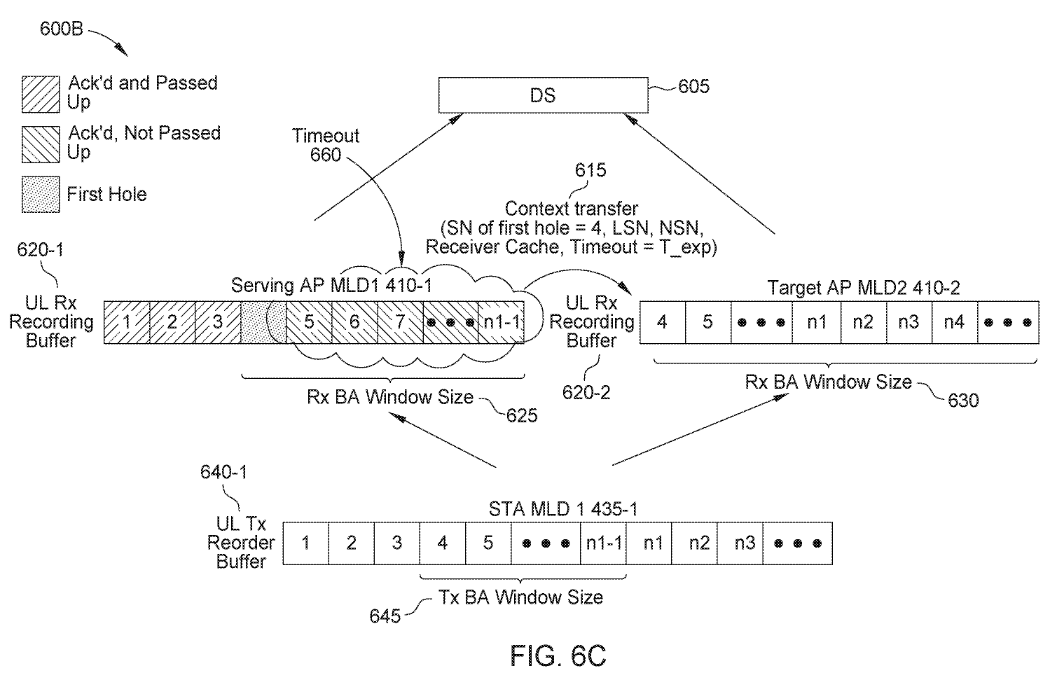

FIG. 6A depicts an example 600A of uplink context transfer with hole reporting and out-of-order delivery, according to some embodiments of the present disclosure.

In this example 600A, a missing MPDU (e.g., a hole) exists in the serving AP’s UL Rx buffer 620-1, and the STA MLD 1 (635-1) initiates the first uplink data flushing strategy, directing the serving AP MLD 1 (610-1) to flush all received MPDUs to the DS 605, including those after holes (e.g., from SN 5 to (n1-1)). In this configuration, the STA MLD 1 (635-1) maintains a single Tx buffer 640-1, so that SN continuity is preserved across roaming.

As discussed in FIG. 5, in UL transmission, MPDUs are transmitted from STA MLD 1 (635-1) through either the serving AP MLD 1 (610-1) or the target AP MLD 2 (610-2), and ultimately delivered to the DS 605. The STA maintains a single UL Tx buffer 640-1 and associated Tx BA window 645. The UL Tx buffer contains MPDUs with SNs 1 through n1 and beyond.

At the serving AP, the UL Rx buffer 620-1 receives MPDUs under a Rx BA window 625. As depicted, SNs 1 to 3 are correctly received and forwarded to the DS, SN=4 is missing, and SNs 5 to (n1-1) are correctly received and acknowledged but have not yet been forwarded to the DS 605 at the time of receiving the roaming request from the STA MLD.

Upon initiating roaming, the STA MLD 1 (635-1) includes a UL data flushing policy preference (also referred to in some embodiments as a hole-handling policy preference) in its roaming request. One option (hereinafter referred to as the first option) is to flush (aka deliver) all received uplink MPDUs to the DS 605, even those after the first hole. This strategy permits out-of-order MPDU delivery to the DS 605. A second option (hereinafter referred to as the second option) is to flush only uplink MPDUs up to the first hole to maintain in-order MPDU delivery to the DS. This strategy is suitable for applications that require strict in-order delivery at the MAC layer. A third option (hereinafter referred to as the third option) is to apply a timeout at the serving AP, where the serving AP waits a bounded amount of time before proceeding to flush any out-of-order MPDUs to the DS.

The choice of flushing strategy may be applied per traffic stream, such as per TID (e.g., TIDs 0 to 7 or TIDs 8-15 for UL flows), per SCSID, per AC, or even uniformly across all traffic. In some embodiments, the STA specifies the strategy in the roaming request. In some embodiments, the serving AP selects the flushing strategy based on implementation-specific logic or traffic classification policies, and indicates the selected option to the STA in the roaming response.

In the embodiment as depicted in FIG. 6A, the STA MLD 1 (635-1) selects the first flushing option: flushing all MPDUs, including those after the hole. The serving AP MLD 1, upon receiving the roaming request, delivers all correctly received MPDUs from its UL Rx buffer 620-1 to the DS 605, even those that follow the hole (e.g., SNs 5 to (n1-1)).

As part of the UL context transfer 615, as illustrated, the serving AP MLD 1 includes the SN of the first hole (e.g., SN=4), and/or the last in-order SN forwarded to the DS (e.g., LSN=3), and the next SN expected to be received at the target AP MLD from the STA MLD (except the holes). In this case, the NSN is n1. In another embodiment, the NSN is transferred to the target AP MLD in this case in the SN of the first missing hole (in this case NSN=4) because the target AP MLD can receive the MPDU for that SN from the STA MLD.

In some embodiments, a set of one or more missing SNs in the UL Rx Reorder buffer at the serving AP (corresponding to the one or more holes) are conveyed using a starting SN plus a bitmap, or a range format using a delta plus the SN of the first hole (e.g., a first hole at SN = 4 with delta = 6 implies missing SNs 4 through 9). The bitmaps offer finer granularity, and the delta indications may provide lower signal overhead and could be useful for hardware/firmware-based implementations.

If no BA agreement is established, the serving AP may instead transfer its receiver cache to the target AP as part of the UL context transfer for a TID or management frames (MMPDUs). The receiver cache contains the record of SNs of previously received MPDUs (e.g., from 1 to x1) or the last SN received for a TID or for MMPDUs and is typically indexed per SN. Similar to the SN information, such as LSN and NSN, the receiver cache enables the target AP to perform duplicate detection and prevent redundant delivery to the DS 605.

In the roaming response, the serving AP MLD 1 may further inform the STA of the missing MPDU information, including the SN of the last in-order MPDU delivered to the DS (e.g., LSN=3), the SN of the last out-of-order MPDU forwarded to the DS (e.g., SN=(n1-1) where the roaming request triggers forwarding of MPDUs that are already acknowledged to the DS), and the SN of the first hole (e.g., SN=4). The information enables the STA MLD 1 (635-1) to determine which MPDUs are still missing and whether it should retransmit those MPDUs to the target AP MLD or discard those MPDUs. In some embodiments, missing MPDU information may be transmitted to the STA MLD (in the roaming response) using a starting SN and a bitmap or an SN range format.

If the traffic is reorder-sensitive (e.g., time sensitive networking (TSN) or extended reality (XR)) or the flow uses an upper-layer SN, the STA may choose to retransmit MPDU with SN=4 to the target AP. If the traffic is not sensitive to reordering, such as AC_VI (Video) or AC_VO (Voice), and retransmission would cause unnecessary delay, the STA may choose to discard SN=4 and move on to transmitting other MPDUs to the target AP.

As depicted, the target AP MLD 2 sets up a new UL Rx buffer 620-1 and associated Rx BA window 630, and begins receiving MPDUs from the STA. If the STA retransmits the missing MPDUs, as depicted, the target AP MLD receives MPDU with SN=4, followed by SN=n1 and onward. The target AP then forwards these data units to the DS 605. This may result in out-of-order delivery at the DS 605 but maintains data completeness. If the STA discards the missing MPDU (with SN=4), the target AP begins to receive MPDUs from SN=n1 onward, and the missing SN=4 is not recovered.

In both embodiments (whether the STA MLD retransmits or discards missing MPDUs), the STA MLD 1 (635-1) continues operation with a single UL Tx buffer 640-1 without requiring a reset of the buffer or renegotiation of the BA agreement with the target AP MLD 2 (610-2).

FIG. 6B depicts an example 600B of uplink context transfer with hole reporting and in-order delivery, according to some embodiments of the present disclosure.

The example 600B illustrates a scenario where a second flushing strategy is applied during UL context transfer in the presence of one or more SN holes in the UL Rx reorder buffer at the serving AP MLD. Unlike FIG. 6A, where the serving AP MLD 1 (610-1) flushed all received MPDUs to the DS 605, including those after the hole (per the first strategy), in this example 600B, the serving AP MLD forwards only in-order MPDUs and stops at the first detected hole. Any MPDUs with SN ≥ 4 are not delivered to the DS by the serving AP.

In this embodiment, the second flushing option is selected, either by the STA MLD 1 (635-1) and indicated in the roaming request or by the serving AP, based on its implementation-specific logic. When determined by the serving AP, the selected strategy is communicated to the STA MLD 1 (635-1) in the roaming response.

During UL context transfer 615, the serving AP MLD 1 (610-1) provides the SN of the first hole (e.g., SN=4), the last in-order SN that was forwarded to the DS (e.g., LSN=3), and the next SN that the target AP expects to receive from the STA MLD (e.g., NSN=4). If a BA agreement is not present, the receiver cache is transferred, along with the SN of the first hole. In some embodiments, missing SNs may be communicated to the target AP MLD more precisely using a start SN plus bitmap or a range format (e.g., a first hole SN plus a delta). The depicted examples 600A and 600B shows only a single hole in the UL Rx reorder buffer at the serving AP MLD. The depicted examples are provided for conceptual clarity. In some embodiments, there can be multiple holes in the RX reorder buffer.

In addition, the roaming response (sent either by the serving AP or by the target AP when roaming is performed directly through the target AP) may inform the STA of the SN of the last in-order MPDU delivered to the DS (e.g., LSN=3), and the SN of the first hole (e.g., SN=4). In some embodiments, the roaming response may indicate the set of missing MPDUs, and this information may be transmitted using a bitmap or a range format. The information enables the STA MLD 1 (635-1) to identify which MPDUs are still missing or undelivered, and thus determine which MPDUs need to be retransmitted to the target AP according to the second flushing strategy (e.g., SN ≥ 4).

In this case, the serving AP MLD 1 (610-1) forwards only the in-order MPDUs (e.g., those with SNs up to LSN=3) to the DS 605. MPDUs beyond the first hole (e.g., SN ≥ 4) are not forwarded. Upon receiving the roaming response, the STA MLD 1 (635-1) resumes uplink transmission starting at SN=4, forwarding the first missing MPDU along with subsequent ones to the target AP MLD 2 (610-2). As depicted, these MPDUs (e.g., SN ≥ 4) are received into the UL Rx buffer 620-2, managed by the Rx BA window 630. The target AP buffers the MPDUs, and forwards the UL data in order to the DS 605.

The second flushing strategy is advantageous because it preserves in-order delivery from the MAC layer to the upper layer and therefore enables a clean transition of the UL data path without duplication, out-of-order delivery or loss. Additionally, the second approach also meets the 602.1q Layer 2 requirement for maintaining in-order delivery from MAC layer to LLC layer.

FIG. 6C depicts an example 600C of uplink context transfer with hole reporting and timeout-based delivery, according to some embodiments of the present disclosure.

In the example 600C, the third flushing strategy (timeout-based delivery) is applied during UL context transfer in the presence of SN holes. The option may be selected by the STA MLD 1 (635-1) via the roaming request, or determined by the serving AP MLD 1 (610-1) based on internal policy or traffic classification and signaled to the STA MLD in the roaming response.

As used herein, the timeout 660 refers to a bounded time window applied to the MPDUs that are received after any missing MPDUs (holes). The timeout is used to avoid indefinite delay in forwarding subsequent MPDUs after any missing MPDUs to the DS 605 and in advancing the Rx BA window. Without such a timeout, the serving AP and/or the target AP may stall transmission of MPDUs to the DS while waiting for a missing MPDU that may never arrive (especially in cases of permanent loss or unacknowledged transmissions). In some embodiments, a STA MLD 1 may also apply a different timeout for UL transmitted MPDUs for which acknowledgement is not received for some time to move on and advance the UL Tx BA window. The applied timeout may hold back the transmission of subsequent MPDUs (e.g., SN ≥ n1) because the Tx BA window cannot be moved forward before acknowledgements for already transmitted MPDUs (e.g., SNs from 4 to n1-1) are received. However, this timeout can be different than the timeout applied at the serving AP or the target AP to determine whether to deliver out-of-order received MPDUs to the DS upon expiration of a timeout.

The timeout duration may be determined by either the serving AP or the target AP. If the serving AP MLD 1 (610-1) determines the timeout, as depicted, the serving AP includes the expiration time as part of the UL context transfer 615 to the target AP MLD 2 (610-2). The serving AP may also signal the timeout value to the STA MLD 1 (635-1) via the roaming response. In embodiments where the target AP makes the determination, the target AP MLD 2 (610-2) signals the timeout to the STA MLD using existing or customized management (or control) frames, such as in the roaming response frame.

As depicted, SN=4 is missing in the UL Rx buffer 620-1 of the serving AP. To inform the STA of the uplink delivery state, the roaming response may also include indicators such as the last in-order SN delivered to the DS (e.g., LSN=3), the last out-of-order SN forwarded to the DS (e.g., SN=(n1-1()), and the SN of the first hole (e.g., SN=4). The information allows the STA MLD 1 (635-1) to understand the precise state of the serving AP’s Rx buffer and determine which MPDUs still require delivery.

Once the timeout expires, the serving AP MLD delivers the MPDUs after the first hole to the DS. In this case, the serving AP may deliver MPDUs with SN 4 to (n1-1) to the DS after the timeout expires. The purpose of the timeout is to allow enough time for the serving AP to receive the UL MPDUs in order before it delivers MPDUs out-of-order to the DS.

In this case, the target AP would receive MPDUs from n1 onwards if MPDUs up to (n1-1) were transmitted to the DS due to timeout expiration before or when the roaming request is received. If timeout had not expired at the serving AP at the time of receiving roaming request, then MPDUs with SN 4 to (n1-1) do not get delivered to the DS by the serving AP, and in this subcase the STA MLD would transmit these MPDUs to the target AP MLD as shown in 620-2.

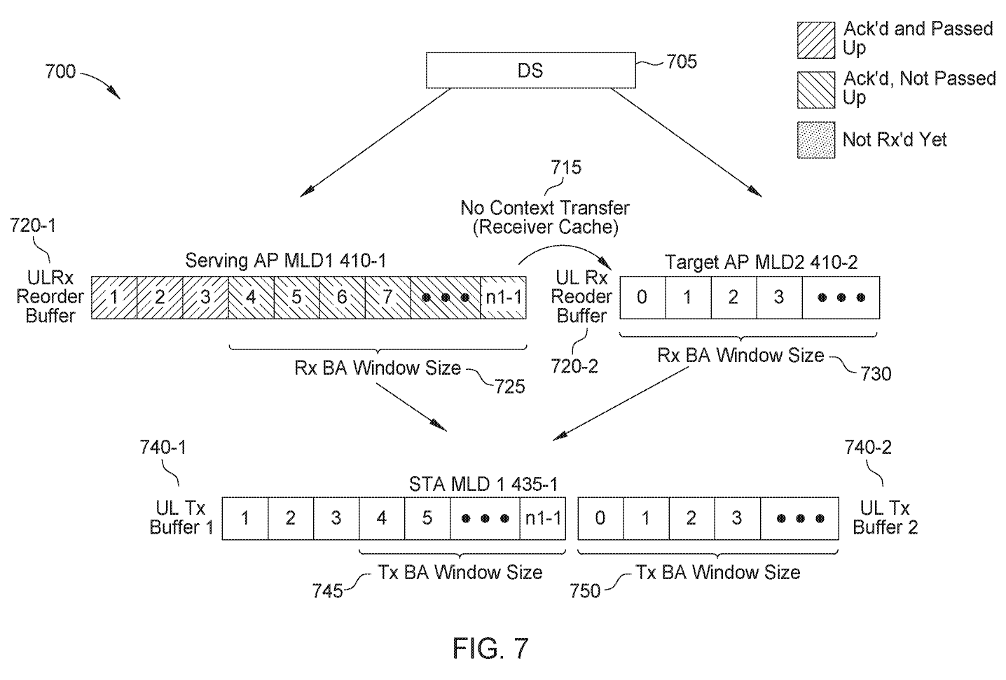

FIG. 7 depicts an example 700 of unlink context transfer for seamless roaming using separate transmit (Tx) buffers, according to some embodiments of the present disclosure.

In the example 700, the STA MLD 1 (735-1) maintains separate UL Tx buffers 740-1 and 740-2 for the serving AP and target AP, different from the embodiments depicted in FIGS. 5 and 6A-6C, where a single UL Tx buffer is maintained. The separation may result in the renegotiation of a new BA agreement upon roaming or simply a corresponding renumbering or resetting of SNs for UL MPDUs. As depicted, the UL Tx buffer 740-1, managed by Tx BA window 745, is associated with the serving AP MLD 1 (710-1), and the UL Tx buffer 740-2, managed by Tx BA window 750, is associated with the target AP MLD 2 (710-2).

As depicted, the STA transmits MPDUs with SNs 1 through (n1-1) to the serving AP. Within the UL Rx buffer 720-1 of the serving AP, SNs 1 to 3 have been passed to the DS 705, and SNs 4 to (n1-1) remain within the Rx BA window 725 and have not yet been delivered to the DS.

Upon roaming, no UL SN context transfer is performed for BA (as depicted by 715). The STA may explicitly indicate in its roaming request that UL SN-related context should not be transferred to the target AP MLD, or it may occur implicitly under an implementation of the serving AP that defaults to reinitialization of the SN at the target AP MLD.

As depicted, the target AP initializes its UL Rx buffer 720-2 and resets the expected SN of UL MPDUs from the STA MLD to be SN 0. As a result, a Rx BA window 730 is set up within the UL Rx buffer 720-2, and the STA begins transmitting with SN starting from 0 using its Tx buffer 740-2. To avoid duplicate data delivery to the DS, the STA MLD does not retransmit MPDUs that were already sent to the serving AP. The STA transmits only MPDUs with SN ≥ n1 to the target AP, which are renumbered starting from 0 under the new BA session. These MPDUs are received and acknowledged within the Rx BA window 730, and subsequently forwarded to the DS 705.

In some embodiments, the information for any missing UL MPDU that was not delivered to the DS by the serving AP can be indicated to the STA MLD in the roaming response. The STA MLD can then transmit that MPDU to the target AP MLD as part of the UL Tx Buffer 2, by assigning a new SN to the MPDU. This can minimize data loss in this configuration.

In some embodiments, when no BA agreement is negotiated for a TID (e.g., for lightweight traffic) or for management MPDUs, the serving AP may optionally transfer its receiver cache to the target AP to aid in duplicate detection for corresponding MPDUs.

The disclosed embodiment in FIG. 7 reduces signaling overhead because no context information (or only lightweight state like a receiver cache) is exchanged between the serving and target APs. Duplicate avoidance is preserved through buffer separation and transmission logic at the STA.

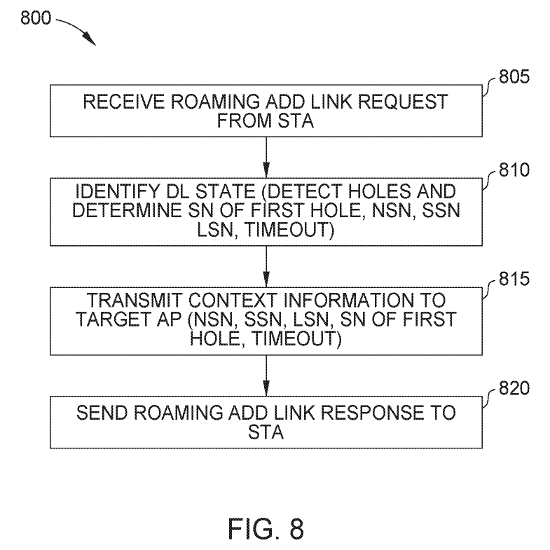

FIG. 8 depicts an example method 800 for a serving AP to perform downlink context transfer during seamless roaming, according to some embodiments of the present disclosure. The example method 800 may be performed by any network device capable of managing DL context transfer during STA roaming. This includes, but is not limited to, a single-link or multi-link AP (e.g., AP MLD 1 (110-1) as depicted in FIG. 1, Source AP 210-1 as depicted in FIGS. 2A-2B, serving AP MLD 1 (310-1) as depicted in FIGS. 3A-3B, and serving AP MLD 1 (410-1) as depicted in FIGS. 4A-4B), a wireless controller, a mesh coordinator, or a cloud-based infrastructure component.

The example method 800 occurs during the roaming preparation phase or roaming execution phase (as depicted in FIGS. 2A and 2B).

At block 805, the serving AP (e.g., AP MLD 1 (110-1) of FIG. 1) receives a roaming request (as depicted by step 240 of FIG. 2B) from an associated STA MLD (e.g., STA MLD 1 (120-1) of FIG. 1). The request signals the STA’s intention to roam to a target AP (e.g., AP MLD 2 (110-2) of FIG. 1). Both serving and target APs are part of the same SMD and connect to a DS (e.g., 105 of FIG. 1) through independent MAC SAPs (e.g., 130 of FIG. 1). As used herein, the roaming request may also be referred to more broadly as a roaming request.

In some embodiments, the serving AP may determine the flushing behavior based on its internal logic or flow-specific delivery requirements. In this configuration, no flushing indication is included in the roaming request. Instead, the serving AP communicates the selected strategy to the STA in the roaming response (e.g., a roaming response).

At block 810, the serving AP evaluates its DL transmission state in preparation for context transfer. This involves examining the Tx buffer and BA scoreboard, and extracting control parameters to inform the target AP’s transmission behavior during or after roaming. One value is the NSN, which corresponds to the first MPDU that the target AP begins to transmit to the STA after roaming (e.g., NSN = n1 as depicted in FIG. 3A). This value marks the beginning of DL data forwarding from the new AP and is used to avoid overlap with the MPDUs already transmitted by the serving AP. The NSN is typically set just beyond the last SN that the serving AP intends to forward, but in some embodiments, the NSN may be spaced further to create a buffer zone (as depicted in FIG. 3B) and account for late-arriving MPDUs from the DS that are still directed to the serving AP at the time of roaming. A second value is the SSN, also referred to as WinStartO, which identifies the first MPDU in the serving AP’s current Tx BA window (e.g., SSN=4 as depicted in FIG. 3A). The SSN reflects the lower bound of the reorder buffer at the STA. With this information, the target AP can avoid transmitting MPDUs that fall outside of the STA’s expected Rx window.

In some embodiments, the LSN is also extracted, which corresponds to the last MPDU for which the serving AP has completed in-order delivery to the DS (e.g., LSN=(n1-4) as depicted in FIG. 3B). If there is a gap between the LSN and the NSN (e.g., SN gap 365 of FIG. 3B), the SN gap may delay buffer advancement or cause blockage at the STA and target AP. With the signaled LSN, the target AP may calculate the size of the gap and take appropriate actions, such as advancing its Tx window and initiating transmission from the NSN without unnecessary delay or stalling.

Following the identification of SN state, in some embodiments, the serving AP proceeds to transmit the remaining buffered MPDUs to the STA before link termination.

At block 815, the serving AP transfers the relevant context information to the target AP (as depicted by step 245 of FIG. 2B). This may occur when the STA maintains a unified DL reorder buffer across APs, allowing the target AP to continue SN usage seamlessly (as depicted in FIGS. 3A-3B). In embodiments where the STA uses separate reorder buffers per AP, context transfer may still occur (as depicted in FIGS. 4B and 4B), depending on implementation policy. When context transfer occurs, the target AP may begin transmitting using SNs that follow the last SN at the serving AP. Upon receiving these MPDUs, the STA may renumber the data units locally (e.g., starting from 0). If context transfer is skipped entirely (as depicted in FIG. 4A), the DS begins forwarding MPDUs to the target AP, starting from a SN that follows those already transmitted to the serving AP. This mechanism helps prevent duplicate delivery at the client device.

At block 820, the serving AP transmits a roaming response to the STA (as depicted by step 250 of FIG. 2B). As used herein, the roaming response may also be referred to more broadly as a roaming response. The response may include context information, such as the SN of the last in-order MPDU delivered to the client (e.g., LSN=3), the SN of the last out-of-order MPDU forwarded to the client (e.g., SN=(n1-1)). Although the response is shown as being sent before DL data transmission, in some embodiments, the response may be transmitted before, during, or after the buffered MPDU transfer.

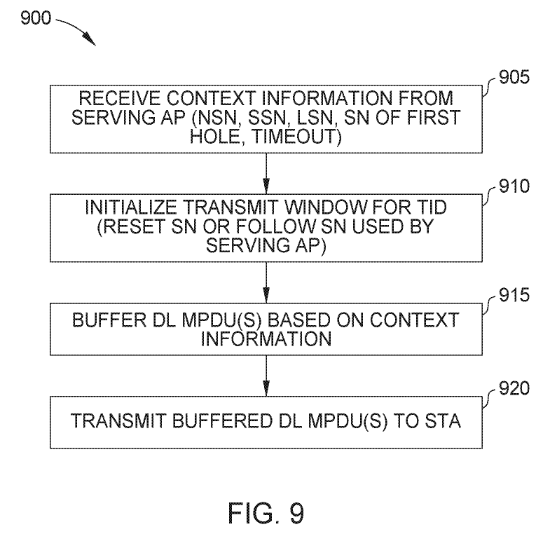

FIG. 9 depicts an example method 900 for a target AP to process downlink context information and resume transmission during seamless roaming, according to some embodiments of the present discourse. The example method 900 may be performed by any network device capable of managing DL context transfer during STA roaming. This includes, but is not limited to, a single-link or multi-link AP (e.g., AP MLD 2 (110-2) as depicted in FIG. 1, target AP 210-2 as depicted in FIGS. 2A-2B, target AP MLD 2 (310-2) as depicted in FIGS. 3A-3B, and serving AP MLD 2 (410-2) as depicted in FIGS. 4A-4B), a wireless controller, a mesh coordinator, or a cloud-based infrastructure component.

The example method 900 occurs during the roaming preparation phase or roaming execution phase (as depicted in FIGS. 2A and 2B).

At block 905, the target AP (e.g., AP MLD 2 (110-2) as depicted in FIG. 1) receives DL context information from the serving AP (as depicted by step 245 of FIG. 2B). The context may include the NSN, which indicates the first SN that the target AP begins to assign to DL MPDUs that it transmits; the SSN (also referred to as WinStartO), which defines the start of the STA’s Rx reorder window; or the LSN, which identifies the last MPDU forwarded to the client device by the serving AP.

In some embodiments, context transfer is omitted entirely, such as when the STA maintains separate Rx reorder buffers per AP and the SN space is not reused (as depicted in FIG. 4A). In some embodiments, context transfer still occurs even when separate buffers are used (as depicted in FIG. 4B). The context transfer allows the target AP to use SNs that follow those used by the serving AP, and the STA then performs local renumbering (e.g., resetting to 0 upon receipt).

At block 910, the target AP initializes the Tx BA window for the relevant TID. If a single Tx sequence space is maintained, the SN counter is continued from the NSN received via context transfer. If separate reorder buffers are used, the SN may be reset to 0 (or another value) as part of a newly established BA agreement with the STA. However, in some embodiments, the target AP may still continue using the serving AP’s SN sequence (as depicted in FIG. 4B), leaving renumbering to be handled on the STA side.

At block 915, the target AP buffers new DL MPDUs from the DS, using the information provided in the context. The buffering begins from the NSN (e.g., NSN=n1) (as depicted in FIG. 3A).

At block 920, the target AP begins transmission of buffered MPDUs to the STA.

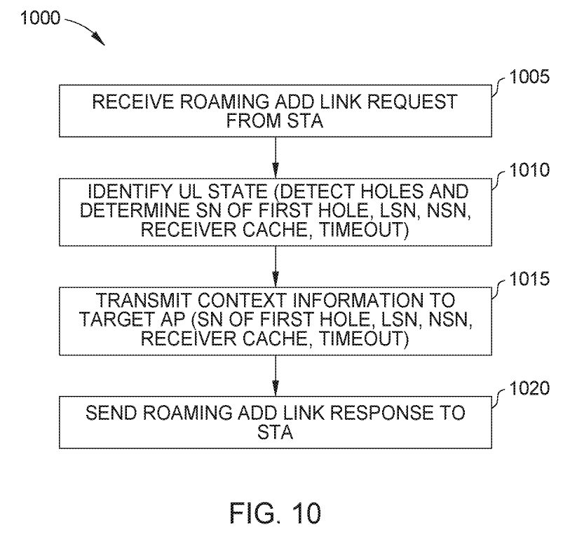

FIG. 10 depicts an example method 1000 for a serving AP to perform uplink context transfer during seamless roaming, according to some embodiments of the present disclosure. The example method 1000 may be performed by any network device capable of managing UL context transfer during STA roaming. This includes, but is not limited to, a single-link or multi-link AP (e.g., AP MLD 1 (110-1) as depicted in FIG. 1, Source AP 210-1 as depicted in FIGS. 2A-2B, serving AP MLD 1 (510-1) as depicted in FIG. 5, serving AP MLD 1 (610-1) as depicted in FIGS. 6A-6C, and serving AP MLD 1 (710-1) as depicted in FIG. 7), a wireless controller, a mesh coordinator, or a cloud-based infrastructure component.

The example method 1000 occurs during the roaming preparation or the roaming execution phase (as depicted in FIGS. 2A and 2B).

At block 1005, the serving AP (e.g., AP MLD 1 (110-1) of FIG. 1) receives a roaming request from the STA. The request indicates the STA’s intent to roam to a target AP (e.g., AP MLD 2 (110-2) of FIG. 1). Both serving and target APs belong to the same SMD and connect to a DS (e.g., 105 of FIG. 1) through independent MAC SAPs (e.g., 130 of FIG. 1). In some embodiments, the request may include the STA’s selected flushing strategy for UL data in cases where holes are present in the AP’s Rx reorder buffer (e.g., 620-1 of FIGS. 6A-6C). The flushing strategies in UL scenarios fall into one of three categories: (1) flush all received MPDUs to the DS, including those after the first hole; (2) flush only up to the first hole to the DS; (3) apply a timeout to coordinate the target AP’s data transmission and flush MPDUs once a timeout expires. These flushing strategies are only applied when the serving AP detects one or more holes in the UL Rx buffer (e.g., missing MPDUs from the STA). When no holes are present, the serving AP simply proceeds with forwarding buffered MPDUs to the DS based on the context transfer (if applicable) (as depicted in FIG. 5) or preset rules when no context transfer is allowed (as depicted in FIG. 7).

In some embodiments, the serving AP determines the flushing strategy based on implementation policy or traffic type, and communicates its decision to the STA in the subsequent roaming response (as depicted by step 250 of FIG. 2B).

At block 1010, the serving AP identifies its UL Rx state for the active TID. The operation may include detecting any holes in the BA scoreboard, and determining one or more control parameters to inform the target AP’s transmission behavior during or after roaming. The parameters include the LSN, which corresponds to the SN of the last in-order MPDU that was forwarded to the DS by the serving AP (e.g., LSN=3 as depicted in FIG. 5), and the NSN, which corresponds to the SN of the first MPDU that the target AP begins to transmit to the DS (e.g., NSN=n1 as depicted in FIG. 5). If holes are present, the SN of the first hole (e.g., SN=4 as depicted in FIGS. 6A-6C), a bitmap, or a range (e.g., starting SN and delta) may be determined and included in UL context transfer. In embodiments where no BA agreement has been established, the serving AP examines its receiver cache, which records MPDUs previously received from the STA. The cache information may be sent to support duplicate detection at the target AP.

Following the determined UL Rx state and flushing strategy, in some embodiments, the serving AP proceeds to forward MPDUs to the DS. When no holes exist, the serving AP forwards all buffered MPDUs that have not yet been passed to the DS. When holes are present, the serving AP transmits MPDUs based on the selected flushing strategy. If the first flushing strategy (flush-all strategy) is selected, the serving AP forwards all correctly received MPDUs to the DS (as depicted in FIG. 6A), including those that come after the hole, even if their SNs are higher than the first missing SN. This may lead to out-of-order delivery at the DS, but is acceptable for order-insensitive flows or when the application layer can reassemble data independently.

If the second flushing strategy (flush-up-to-first-hole strategy) is selected, the serving AP forwards only MPDUs up to the first hole (as depicted in FIG. 6B). This approach preserves in-order delivery so that the DS and upper layers do not receive reordered data.

If the third flushing strategy (timeout-based strategy) is selected, the target AP or the STA waits for the specified timeout interval before initiating UL transmission of MPDUs (as depicted in FIG. 6C). The timeout value may be determined by the serving AP (e.g., included in the UL context transfer to the target AP and/or in the roaming response to the STA). Depending on implementation, transmission after timeout expiration may be initiated either by the target PA or the STA. In one embodiment, the target AP may buffer MPDUs received from the STA during the timeout period and begin forwarding these MPDUs to the DS once the timeout expires. In another embodiment, the STA may wait for the timeout to expire before initiating transmission of the missing and subsequent MPDUs to the target AP. In the third flushing strategy, the serving AP may either forward MPDUs only up to the first hole (e.g., preserving in-order delivery) or flush all buffered MPDUs, including those after the first hole (e.g., when out-of-order delivery is acceptable).

In embodiments where the STA maintains separate Tx buffers and no context transfer occurs, the target AP simply forwards the MPDUs it receives from the STA, which are selected by the STA to exclude any that were already sent to the serving AP (e.g., starting from n1) to avoid duplicate delivery to the DS (as depicted in FIG. 7).

At block 1015, the serving AP transmits the UL context to the target AP (as depicted by step 245 of FIG. 2B). The transfer may occur when the STA maintains a single Tx buffer (e.g., 640-1 of FIG. 6) and continuous SN space across APs. In this configuration, the target AP may pick up the transmission window from where the serving AP left off (e.g., starting from n1) (as depicted in FIG. 6). In embodiments where the STA maintains separate Tx buffers (e.g., 740-1 and 740-2 of FIG. 7), the UL SN space and BA agreement may be reset during the roaming, so that the target AP starts with a fresh BA session and begins under a new SN space (e.g., starting from SN=0). In this configuration, UL context transfer is omitted because there is no continuity of SN space across the APs. Instead, the serving AP relies on the STA to avoid duplicate UL transmission. More specifically, the STA skips MPDUs that are already sent to the serving AP and only sends new, untransmitted MPDUs to the target AP (as depicted in FIG. 7). The lightweight approach reduces complexity and signaling overload, but it risks data loss in scenarios where holes exist in the serving AP’s UL Rx buffer (e.g., when a transmitted MPDU was not received by the serving AP). However, this approach may be acceptable for order-insensitive traffic flows, such as AC_VO or AC_VI.

At block 1020, the serving AP transmits a roaming response to the STA (as depicted by step 250 of FIG. 2B). The response may include one or more control parameters that help the STA determine which MPDUs should be sent to the target AP for UL transmission. These parameters may include the LSN (e.g., LSN=3 as depicted in FIG. 5), the SN of the last out-of-order MPDU forwarded to the DS (e.g., SN=(n1-1) as depicted in FIGS. 6A-6C), and the SN of the first hole (e.g., SN=4 as depicted in FIGS. 6A-6C). Although the response is shown as being sent before UL data transmission, in some embodiments, the response may be transmitted before, during, or after the buffered MPDU transfer.

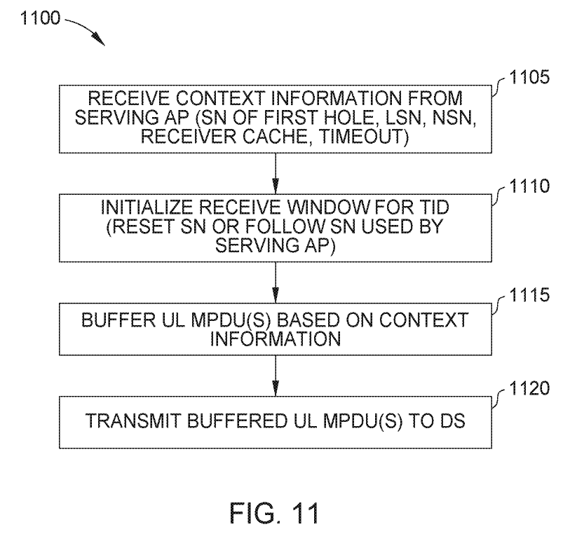

FIG. 11 depicts an example method 1100 for a target AP to process uplink context and resume transmission during seamless roaming, according to some embodiments of the present discourse. The example method 1100 may be performed by any network device capable of managing UL context transfer during STA roaming. This includes, but is not limited to, a single-link or multi-link AP (e.g., AP MLD 1 (110-1) as depicted in FIG. 1, target AP 210-1 as depicted in FIGS. 2A-2B, target AP MLD 2 (510-2) as depicted in FIG. 5, target AP MLD 2 (610-2) as depicted in FIGS. 6A-6C, and serving AP MLD 2 (710-2) as depicted in FIG. 7), a wireless controller, a mesh coordinator, or a cloud-based infrastructure component.

The example method 1100 occurs during the roaming preparation phase or the roaming execution phase (as depicted in FIGS. 2A and 2B).

At block 1105, the target AP receives UL context information from the serving AP, which may include the LSN, which corresponds to the last in-order MPDU that the serving AP forwarded to the DS), and the NSN, which corresponds to the first MPDU that the target AP is expected to deliver. If a hole exists in the sequence, the context may also include the SN of the first hole, or more precise representations such as a bitmap or a range-based indicator (e.g., delta from the first missing SN).

In embodiments where no BA agreement was established between the STA and serving AP, the context may instead include receiver cache information, which includes data about previously received MPDUs for duplicate detection. In embodiments where the third flushing strategy (timeout-based strategy) is selected, the context may further include a timeout value indicating how long the target AP or STA is expected to wait before transmitting UL MPDUs.

In some embodiments, context transfer is omitted entirely (as depicted in FIG. 7). For example, if the STA maintains separate Tx buffers for each AP and SN space is reset, the target AP does not require sequence continuity information.

In embodiments where separate Tx buffers are used and BA is not established, receiver cache may be transmitted to enable the target AP to perform duplicate detection and prevent redundant forwarding to the DS.

At block 1110, the target AP initializes its received window for the relevant TID. When the STA maintains a single Tx buffer, the SN counter is continued from the NSN provided in the context transfer (as depicted in FIG. 5). When the STA maintains separate Tx buffers, the SN may be reset to 0 (or another value) as part of a newly established BA agreement with the target AP (e.g., NSN=n1 is renumbered to SN=0). In this configuration, the target AP begins its Rx window from SN=0 (as depicted in FIG. 7).

At block 1115, the target AP buffers new UL MPDUs from the STA based on the UL context information. When no holes are present, the target AP starts buffering beginning from the NSN (e.g., NSN=n1) (as depicted in FIG. 5). If holes are present and the first flushing strategy (flush-all) is selected, the target AP buffers both the missing MPDU(s) (e.g., SN=4) and those starting from the NSN (e.g., NSN=n1) (as depicted in FIG. 6A). If the second option (flush-up-to-first-hole) is selected, the target AP buffers MPDUs from the first hole (e.g., SN≥4) (as depicted in FIG. 6B). In some embodiments, the target AP may discard the missing MPDUs (e.g., SN=4), based on the type of the traffic. If the third flushing strategy (timeout-based) is selected, the target AP’s behavior may vary based on traffic type. For example, the target AP may buffer only the missing MPDU(s) and resume at NSN for order-insensitive traffic flows (e.g., TSN, XR), or start buffering from the first hole onward for order-sensitive traffic flows that require full reassembly before DS forwarding.

At block 1120, the target AP initiates transmission of the buffered MPDUs to the DS. If a timeout-based flushing strategy is used, the target AP begins transmission once the timeout expires, preventing unnecessary delay or stalling. The timeout value may be determined by the serving AP (e.g., communicated via UL context transfer), or selected by the target AP itself, based on internal policy of QoS parameters. In some embodiments, the timeout may be applied to the STA (e.g., communicated via the roaming response), such that the STA initiates UL transmission to the target AP once the timeout expires. This approach ensures that data is not transmitted prematurely, reducing the risk of unnecessary retransmission or redundant delivery. This mechanism is beneficial for flows where in-order delivery is desired (or required), or for conserving transmission resources in congested environments, particularly under tight scheduling constraints in multi-link operations.

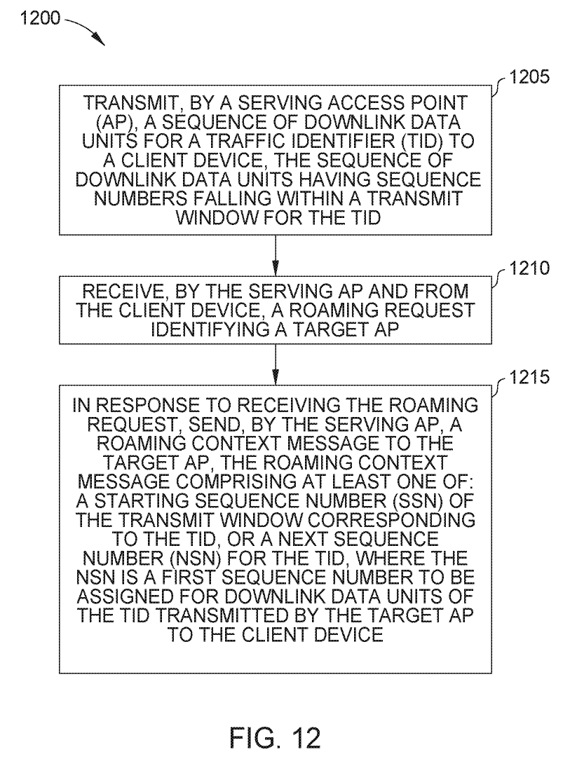

FIG. 12 is a flow diagram depicting an example method 1500 for downlink context transfer, according to some embodiments of the present disclosure.

At block 1205, a serving AP (e.g., serving AP MLD 1 (310-1) of FIG. 3A) transmits a sequence of downlink data units for a traffic identifier (TID) to a client device (e.g., STA MLD 1 (335-1) of FIG. 3A), the sequence of downlink data units having sequence numbers falling within a transmit window for the TID.

At block 1210, the serving AP receives, from the client device, a roaming request identifying a target AP.

At block 1215, in response to receiving the roaming request, the serving AP sends a roaming context message (e.g., 315 of FIG. 3A) to the target AP, the roaming context message comprising at least one of: a starting sequence number (SSN) of the transmit window corresponding to the TID, or a next sequence number (NSN) for the TID, where the NSN is a first sequence number to be assigned for downlink data units of the TID transmitted by the target AP to the client device.

In some embodiments, a size of the transmit window may be determined based on a buffer size negotiated in a block acknowledgement agreement for the TID with the client device, and the transmit window may comprise a range of sequence numbers assigned to downlink data units transmitted to the client device, the range corresponding to a receive buffer window maintained by the client device.

In some embodiments, the NSN may be determined by the serving AP to ensure availability of sufficient sequence numbers for assigning to downlink data units already received by the serving AP from a distribution system (DS) and additional downlink data units of the TID that are subsequently received from the DS for the client device.

In some embodiments, the serving AP may transmit a roaming response to the client device, where the roaming response comprises the NSN for the TID.

In some embodiments, the serving AP may transmit data to the client device, comprising at least one of: a last sequence number (LSN) to the client device, where the LSN corresponds to a sequence number associated with a last downlink data unit transmitted by the serving AP to the client device for the TID, or an indication that downlink data transmission from the serving AP to the client device for the TID has terminated.

In some embodiments, the roaming request may further comprise an indication to the serving AP to provide a SN context for downlink in a roaming response, where the SN context for downlink comprises at least one of the NSN or the LSN.

In some embodiments, the operation of transmitting the LSN to the client device may comprise at least one of: providing a value of the LSN to the client device in a roaming response, signaling the LSN to the client device in-band within a downlink data frame, providing the LSN to the client device in a management frame, or providing the LSN to the client device in a control frame.

In some embodiments, the operation of signaling the LSN to the client device in-band within a downlink data frame may comprise one of: signaling the LSN in an A-Control field of a quality of service (QoS) Null data frame, signaling the LSN in an A-Control field in a media access control (MAC) header of a QoS data frame, signaling an empty buffer for the TID in the A-Control field or another field in the MAC header, implying that a sequence number in the MAC header of the downlink data frame corresponds to the LSN, or signaling no more data for the TID in the A-Control field or another field in the MAC header, implying that a sequence number in the MAC header of the downlink data frame corresponds to the LSN.

In some embodiments, the target AP may maintain a target transmit window comprising sequence numbers to be assigned for downlink data units to be transmitted to the client device for the TID, a start of the target transmit window may be initialized to the SSN received from the serving AP, a size of the target transmit window may be determined based on a buffer size negotiated in a block acknowledgement (BA) agreement for the TID with the client device, and the target AP may initiate transmission of downlink data units associated with the TID to the client device beginning with the NSN.

In some embodiments, the serving AP may transmit the LSN to the target AP, where the target AP advances a start of the target transmit window to a highest sequence number among the NSN or sequence numbers of downlink data units for the TID that were already transmitted and acknowledged by the client device.

In some embodiments, the target AP may comprise a target AP multi-link device (MLD), and the target AP MLD may transmit downlink data units to the client upon receiving an indication that the client device has exited power save mode on one or more links established with the target AP MLD.

In some embodiments, the client device may maintain a single receive buffer (e.g., 340 of FIG. 3A) for downlink data units associated with the TID received from the serving AP and the target AP, and sequence numbers used by the target AP for the TID follow sequence numbers used by the serving AP for the TID.

In some embodiments, the client device may maintain a first receive buffer (e.g., 410-1 of FIGS. 4A-4B) for downlink data units associated with the TID received from the serving AP, the client device may maintain a second receive buffer (e.g., 410-2 of FIGS. 4A-4B) for downlink data units associated with the TID received from the target AP, and sequence numbers used by the target AP for the TID follow sequence numbers used by the serving AP for the TID (as depicted in FIG. 4B).

In some embodiments, the client device may maintain a first receive buffer (e.g., 410-1 of FIGS. 4A-4B) for the TID for downlink data units associated with the TID received from the serving AP, the client device may maintain a second receive buffer (e.g., 410-2 of FIGS. 4A-4B) for the TID for downlink data units associated with the TID received from the target AP, and sequence numbers used by the target AP for downlink data units for the TID start from a reset value and follow a new sequence number space, without following sequence numbers used by the serving AP for the TID(as depicted in FIG. 4A).

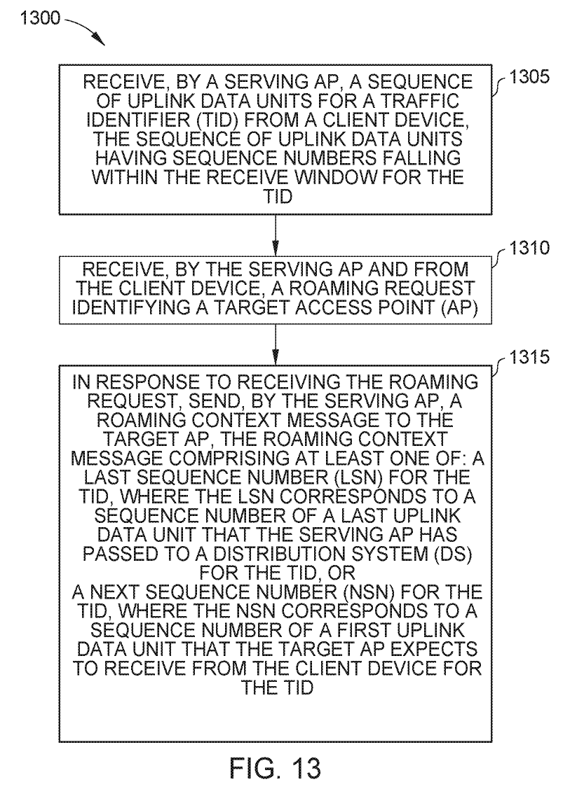

FIG. 13 is a flow diagram depicting an example method 1600 for uplink context transfer, according to some embodiments of the present disclosure.

At block 1305, a serving AP (e.g., serving AP MLD 1 (510-1) of FIG. 5) receives a sequence of uplink data units for a traffic identifier (TID) from a client device (e.g., STA MLD 1 (535-1) of FIG. 5), the sequence of uplink data units having sequence numbers falling within the receive window for the TID.

At block 1310, the serving AP receives, from the client device, a roaming request identifying a target AP (e.g., target AP MLD 2 (510-2) of FIG. 5).

At block 1315, in response to receiving the roaming request, the serving AP sends a roaming context message (e.g., 515 of FIG. 5) to the target AP, the roaming context message comprising at least one of: a last sequence number (LSN) for the TID, where the LSN corresponds to a sequence number of a last uplink data unit that the serving AP has passed to a distribution system (DS) for the TID (e.g., 505 of FIG. 5), or a next sequence number (NSN) for the TID, where the NSN corresponds to a sequence number of a first uplink data unit that the target AP expects to receive from the client device for the TID.

In some embodiments, the target AP, in response to receiving the roaming context message, may be configured to perform duplicate detection based on the LSN or NSN, and transmit, to the DS, one or more uplink data units for the TID having sequence numbers beginning with a value equal to the NSN or greater than the LSN.

In some embodiments, the receive window (e.g., 525 of FIG. 5) may be determined based on buffer size negotiated as part of a block acknowledgement agreement for the TID with the client device and define a range of sequence numbers assigned to uplink data units received at the client device, the range corresponding to a transmit buffer window (e.g., 545 of FIG. 5) maintained by the client device.

In some embodiments, the client device may maintain a single transmit buffer (e.g., 540-1 of FIG. 5) for uplink data units associated with the TID transmitted to the serving AP and the target AP, and sequence numbers assigned by the client device for uplink data units transmitted to the target AP follow sequence numbers assigned by the client device for uplink data units transmitted to the serving AP (as depicted in FIG. 5).

In some embodiments, the client device may maintain a first transmit buffer (e.g., 540-1 of FIG. 5) for uplink data units associated with the TID transmitted to the serving AP, the client device may maintain a second transmit buffer (e.g., 540-2 of FIG. 5) for uplink data units associated with the TID transmitted to the target AP, and sequence numbers assigned by the client device for uplink data units transmitted to the target AP are reset without following sequence numbers assigned by the client device for uplink data units transmitted to the serving AP.

In some embodiments, the sequence of uplink data units received by the serving AP in the receive window may comprise one or more missing uplink data units caused by incomplete delivery from the client device to the serving AP.

In some embodiments, the roaming context message (e.g., 615 of FIGS. 6A-6C) may further comprise at least one of: a sequence number of a first missing uplink data unit within the receive window, a range of sequence numbers corresponding to the one or more missing uplink data units within the receive window, or a bitmap corresponding to the one or more missing uplink data units within the receive window.

In some embodiments, in response to receiving the roaming request, the serving AP may transmit, to the client device, a roaming response comprising at least one of: a sequence number of the first missing uplink data unit, a sequence number of an uplink data unit immediately preceding the first missing uplink data unit, a sequence number of a last out-of-order uplink data unit delivered to the DS after the first missing uplink data unit, a range of sequence numbers corresponding to the one or more missing uplink data units within the receive window, or a bitmap corresponding to the one or more missing uplink data units within the receive window.

In some embodiments, the roaming request comprises an indication for the serving AP to transmit a SN context for uplink to the client device in roaming response, where the SN context for uplink comprises at least one of: a sequence number of the first missing uplink data unit, a sequence number of an uplink data unit immediately preceding the first missing uplink data unit, a sequence number of a last out-of-order uplink data unit delivered to the DS after the first missing uplink data unit, a range of sequence numbers corresponding to the one or more missing uplink data units within the receive window, or a bitmap corresponding to the one or more missing uplink data units within the receive window.

In some embodiments, in response to receiving the roaming response, the client device may transmit, to the target AP, at least one of: the uplink data units for the TID having sequence numbers beginning with the first missing uplink data unit but within the receive window, or the uplink data units for the TID that correspond to the one or more missing uplink data units indicated in the roaming response.

In some embodiments, the roaming request may further comprise an indication to the serving AP to transmit uplink data units for the TID to the DS, comprising uplink data units up to the first missing uplink data unit and uplink data units that are received out-of-order and have sequence numbers after the first missing uplink data unit and within the receive window (as depicted in FIG. 6A).

In some embodiments, in response to receiving the roaming request, the serving AP may transmit, to the DS, the uplink data units that have already been received within the receive window, comprising uplink data units up to the first missing uplink data unit and uplink data units that are received out-of-order and have sequence numbers after the first missing uplink data unit.

In some embodiments, the target AP may be configured to identify the one or more missing uplink data units, and transmit, to the DS, the identified missing uplink data units and one or more other uplink data units having sequence numbers beginning with the NSN based on uplink data units received from the client device (as depicted in FIG. 6A).

In some embodiments, the roaming request may further comprise an indication to the serving AP to transmit uplink data units for the TID to the DS up to the first missing uplink data unit within the receive window, and uplink data units having sequence numbers after the first missing uplink data unit are withheld from delivery to the distribution system.

In some embodiments, in response to receiving the roaming request, the serving AP may transmit, to the DS, the sequence of uplink data units received within the receive window up to the first missing uplink data unit (as depicted in FIG. 6B).

In some embodiments, the target AP may be configured to identify uplink data units received from the client device for the TID having sequence numbers beginning with the first missing uplink data unit, and transmit, to the DS, the identified uplink data units (as depicted in FIG. 6B).

In some embodiments, the serving AP may apply a timeout to one or more out-of-order uplink data units having sequence numbers after the first missing uplink data unit and falling within the receive window, and upon detecting expiration of the timeout, delivering, by the serving AP, the one or more out-of-order uplink data units having sequence numbers after the first missing uplink data unit to the DS (as depicted in FIG. 6C).

In some embodiments, the target AP may be configured to maintain a target receive window for the uplink data units received from the client device, and the target AP may be configured to: apply a timeout to one or more out-of-order uplink data units having sequence numbers falling within the target receive window and after the first missing uplink data unit received from the client device, and, upon detecting an expiration of the timeout, deliver to the DS, the one or more out-of-order uplink data units having sequence numbers after the first missing uplink data unit (as depicted in FIG. 6C).

In some embodiments, the roaming response may comprise an indication that the out-of-order uplink data units in the receive window are delivered to the DS after the expiration of the timeout, and the client device may use the indication to determine not to transmit uplink data units that are received out-of-order on the serving AP after the first missing uplink data unit, to the target AP (as depicted in FIG. 6C).

In some embodiments, the client device may be configured to identify one or more uplink data units associated with the TID and beginning with the NSN, reassign new sequence numbers for the identified one or more uplink data units starting from a reset value, and transmit the reassigned uplink data units to the target AP using a new sequence number space (as depicted in FIG. 7).

In some embodiments, the serving AP may determine a flushing strategy for transmitting uplink data units to the DS in a presence of the one or more missing uplink data units, and transmit an indication of the flushing strategy to the client device in a roaming response.

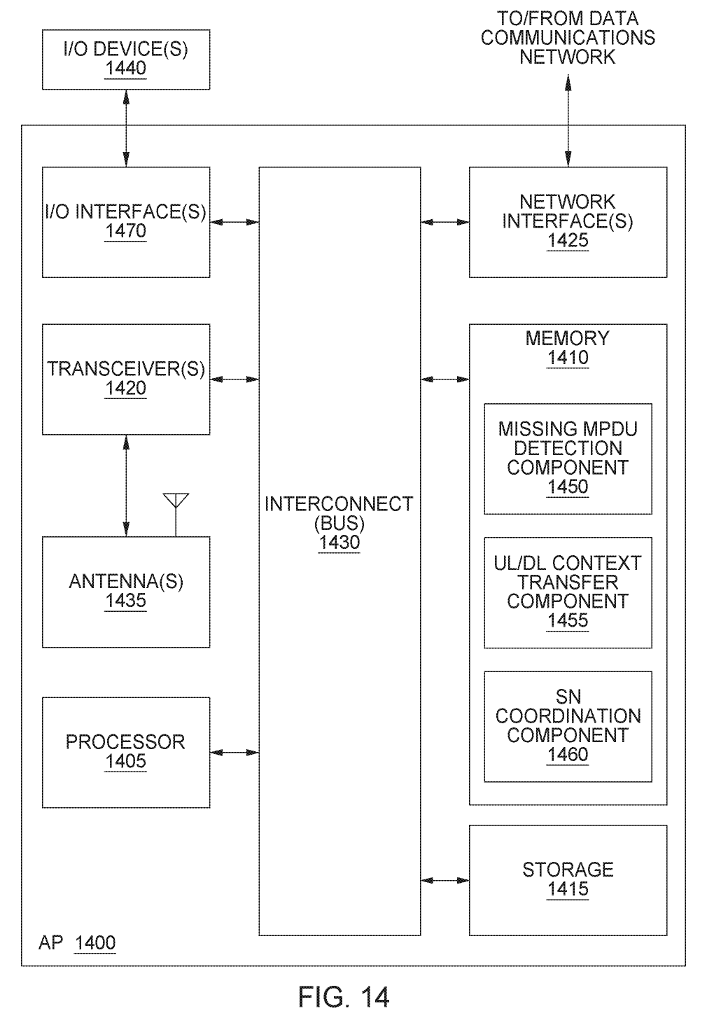

FIG. 14 depicts an example network device 1400 configured to perform various aspects of the present disclosure, according to some aspects of the present disclosure. The example network device 1400 may correspond to a serving AP or target AP within a SMD, as depicted in FIGS. 1, 2A-2B, 3A-3B, 4A-4B, 5, 6A-6C and 7.

As illustrated, the client device 1400 includes a processor 1405, memory 1410, storage 1415, one or more transceivers 1420, one or more I/O interfaces 1480, and one or more network interfaces 1425. In some embodiments, I/O devices 1470 are connected via the I/O interface(s) 1480. Further, via the network interface 1425, the network device 1400 can be communicatively coupled with one or more other devices and components (e.g., via a network, which may include the Internet, local network(s), and the like). Each of the components is communicatively coupled by one or more buses 1430. In some embodiments, one or more antennas 1435 may be coupled to the transceivers 1420 for transmitting and receiving wireless signals.

The processor 1405 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1405 processes information received through the transceiver 1420, I/O interfaces 1480, and the network interfaces 1425. The processor 1405 retrieves and executes programming instructions stored in memory 1410, as well as stores and retrieves application data residing in storage 1415.

The storage 1415 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1415 may store a variety of data for the efficient functioning of the system.

The memory 1410 may include random access memory (RAM) and read-only memory (ROM). The memory 1410 may store processor-executable software code containing instructions that, when executed by the processor 1405, enable the network device 1400 to perform various functions described herein for wireless communication.

When the network device 1400 operates as a serving AP (e.g., 310-1 of FIG. 3A), the memory 1410 includes a missing MPDU detection component 1450, an UL/DL context transfer component 1455, and a SN coordination component 1460.

In one embodiment, the missing MPDU detection component 1450 is configured to identify gaps in the transmit or receive sequence space. In the UL direction, the component 1450 monitors the UL receive buffer and the BA scoreboard to detect unreceived MPDUs from the STA (e.g., due to wireless errors or collisions). In the downlink direction, the component 1450 tracks the transmit buffer and acknowledgement state to determine whether any DL MPDUs have not yet been received from the DS. The component 1450 flags any detected holes, which may be encoded as a single SN, a bitmap, or a sequence range, and the information is then provided for UL/DL context transfer and data flushing.

In one embodiment, the UL/DL context transfer component 1455 is configured to construct and manage the signaling of context information to the target AP during roaming. In the DL case, the context transfer may include the SSN, NSN, LSN, and missing MPDU indicators for maintaining reorder buffer alignment. In the UL case, the component 1455 may transfer the LSN, NSN, receiver cache (when no BA agreement is established), and missing MPDU indicators to the target AP.

In one embodiment, the SN coordination component 1460 is configured to manage SN alignment across APs. The component 1460 identifies the appropriate NSN to be used by the target AP, considering the outstanding buffered data, potential DS mapping lag, and delivery status. The component 1460 maintains coordinated and seamless continuation of delivery during roaming.

When the network device 1400 operates as a target AP, the memory includes at least the SN coordination component 1460, which performs SN space initialization and alignment for resumed delivery. In DL scenarios, the component 1460 uses the received NSN and SSN to initialize the Tx BA window and start buffering and transmitting DL MPDUs in sequence or with renumbering (e.g., reset to 0). In UL scenarios, the component 1460 sets the Rx window based on the received NSN or resets to zero, and uses the received context information to detect and discard duplicates. The component 1460 may also interpret timeout value and coordinate delivery timing in timeout-based flushing strategies.

Although depicted as a discrete component for conceptual clarity, in some embodiments, the operations of the depicted components (and others not illustrated) may be combined or distributed across any number of components. Further, although depicted as software residing in memory 1410, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claimed is:

1. A method, comprising:
establishing, by a first access point (AP) multi-link device (MLD) of a seamless mobility domain (SMD), an association between the SMD and a non-AP MLD,
wherein the SMD comprises the first AP MLD and a second AP MLD, and
wherein the association comprises at least one link between a first affiliated AP of the first AP MLD and a first STA of the non-AP MLD;
receiving, by the first AP MLD, uplink (UL) data media access control (MAC) protocol data units (MPDUs) from the non-AP MLD, each UL data MPDU having a corresponding sequence number (SN);
transmitting content of the UL data MPDUs received from the non-AP MLD to a distribution system;
maintaining, by the first AP MLD, UL context information of the association, the UL context information comprising data indicating a SN of a last UL data MPDU received from, and acknowledged to, the non-AP MLD and forwarded to the distribution system;
receiving, by the first AP MLD, a roaming request from the non-AP MLD, the roaming request indicating intent to roam to the second AP MLD;
transferring, by the first AP MLD, uplink (UL) context information to the second AP MLD, the UL context information comprising a SN of the last UL data MPDU received from, and acknowledged to, the non-AP MLD and forwarded to the distribution system; and
transmitting a roaming response to the non-AP MLD, the roaming response comprising an indication of the SN of the last UL data MPDU received from, and acknowledged to, the non-AP MLD and forwarded to the distribution system.

2. The method of claim 1, further comprising transferring, in response to the roaming request, any remaining UL data MPDUs received from, and acknowledged to, the non-AP MLD that have not been transmitted to the distribution system.

3. The method of claim 1, wherein the UL data MPDUs correspond to a first traffic identifier (TID) of a plurality of TIDs.

4. The method of claim 1, further comprising transmitting, by the first AP MLD, link setup data to the second AP MLD to cause the second AP MLD to set up one or more links between a first affiliated AP of the second AP MLD and a first STA of the non-AP MLD.

5. The method of claim 1, wherein the roaming request is received in a roaming preparation phase.

6. The method of claim 1, wherein the roaming request is received in a roaming execution phase.

7. The method of claim 1, wherein the UL context information transmitted to the second AP MLD further comprises a next sequence number corresponding to a SN of an UL data MPDU that the second AP MLD is expected to transmit to the distribution system.

8. The method of claim 1, further comprising:
maintaining, by the first AP MLD, a downlink (DL) transmit buffer comprising DL MPDUs and corresponding sequence numbers for the MPDUs, the MPDUs transmitted to or to be transmitted to the non-AP MLD;
maintaining a SN of a first unacknowledged DL MPDU in the DL transmit buffer (WinStartO); and
responsive to the roaming request, transferring, by the first AP MLD, DL context information to the second AP MLD, the DL context information comprising a SN of the first unacknowledged DL MPDU (WinStartO) and a next SN value indicating a SN
corresponding to a first DL MPDU that the second AP MLD is expected to transmit to the non-AP MLD.

9. The method of claim 8, wherein the roaming response transmitted to the non-AP MLD comprises the DL context information.

10. The method of claim 8, wherein the DL context information transmitted to the second AP MLD further comprises a buffer size of a block acknowledgement agreement with the non-AP MLD.

11. An access point (AP) multi-link device (MLD) of a seamless mobility domain (SMD), comprising:
a processor;
two or more affiliated APs, each affiliated AP operative to establish a corresponding link with an affiliated station of a non-AP MLD, and
a memory communicatively coupled to the processor, wherein the memory comprises a Multi-Link Operation (MLO) management logic configured to perform operations comprising:
establishing, by the AP MLD, an association between a seamless mobility domain (SMD) and a non-AP MLD, wherein the SMD comprises the AP MLD and a second AP MLD, wherein the second AP MLD comprises two or more affiliated APs and the non-AP MLD comprises two or more stations (STAs), and wherein the association comprises at least one link between a first affiliated AP of the AP MLD and a first STA of the non-AP MLD;
receiving, by the AP MLD, uplink (UL) data media access control (MAC) protocol data units (MPDUs) from the non-AP MLD, each UL data MPDU having a corresponding sequence number (SN);
transmitting content of the UL data MPDUs received from the non-AP MLD to a distribution system;
maintaining, by the AP MLD, UL context information of the association, the UL context information comprising data indicating a SN of a last UL data MPDU received from, and acknowledged to, the non-AP MLD and forwarded to the distribution system;
receiving, by the AP MLD, a roaming request from the non-AP MLD, the roaming request indicating intent to roam to the second AP MLD;
transferring, by the AP MLD, uplink (UL) context information to the second AP MLD, the UL context information comprising a SN of the last UL data MPDU received from, and acknowledged to, the non-AP MLD and forwarded to the distribution system; and
transmitting a roaming response to the non-AP MLD, the roaming response comprising an indication of the SN of the last UL data MPDU received from, and acknowledged to, the non-AP MLD and forwarded to the distribution system.

12. The AP MLD of claim 11, the operations further comprising transferring, in response to the roaming request, any remaining UL data MPDUs received from, and acknowledged to, the non-AP MLD that have not been transmitted to the distribution system.

13. The AP MLD of claim 11, wherein the UL data MPDUs correspond to a first traffic identifier (TID) of a plurality of TIDs.

14. The AP MLD of claim 11, the operations further comprising transmitting, by the first AP MLD, link setup data to the second AP MLD to cause the second AP MLD to set up one or more links between a first affiliated AP of the second AP MLD and a first STA of the non-AP MLD.

15. The AP MLD of claim 11, wherein the roaming request is received in a roaming preparation phase.

16. The AP MLD of claim 11, wherein the roaming request is received in a roaming execution phase.

17. The AP MLD of claim 11, wherein the UL context information transmitted to the second AP MLD further comprises a next sequence number corresponding to a SN of an UL data MPDU that the second AP MLD is expected to transmit to the distribution system.

18. The AP MLD of claim 11, the operations further comprising:
maintaining, by the first AP MLD, a downlink (DL) transmit buffer comprising DL MPDUs and corresponding sequence numbers for the MPDUs, the MPDUs transmitted to or to be transmitted to the non-AP MLD;
maintaining a SN of a first unacknowledged DL MPDU in the DL transmit buffer (WinStartO); and
responsive to the roaming request, transferring, by the first AP MLD, DL context information to the second AP MLD, the DL context information comprising a SN of the first unacknowledged DL MPDU (WinStartO) and a next SN value indicating a SN corresponding to a first DL MPDU that the second AP MLD is expected to transmit to the non-AP MLD.

19. The AP MLD of claim 18, wherein the roaming response transmitted to the non-AP MLD comprises the DL context information.

20. The AP MLD of claim 18, wherein the DL context information transmitted to the second AP MLD further comprises a buffer size of a block acknowledgement agreement with the non-AP MLD.

21. A non-transitory computer readable storage medium comprising instructions that when executed configure one or more processors of an access point (AP) multi-link device (MLD) to perform operations comprising:
establishing, by the AP MLD, an association between a seamless mobility domain (SMD) and a non-AP MLD, wherein the SMD comprises the AP MLD and a second AP MLD, and wherein the association comprises at least one link between a first affiliated AP of the AP MLD and a first STA of the non-AP MLD;
receiving, by the AP MLD, uplink (UL) data media access control (MAC) protocol data units (MPDUs) from the non-AP MLD, each UL data MPDU having a corresponding sequence number (SN);
transmitting content of the UL data MPDUs received from the non-AP MLD to a distribution system;
maintaining, by the AP MLD, UL context information of the association, the UL context information comprising data indicating a SN of a last UL data MPDU received from, and acknowledged to, the non-AP MLD and forwarded to the distribution system;
receiving, by the AP MLD, a roaming request from the non-AP MLD, the roaming request indicating intent to roam to the second AP MLD;
transferring, by the AP MLD, uplink (UL) context information to the second AP MLD, the UL context information comprising a SN of the last UL data MPDU received from, and acknowledged to, the non-AP MLD and forwarded to the distribution system; and
transmitting a roaming response to the non-AP MLD, the roaming response comprising an indication of the SN of the last UL data MPDU received from, and acknowledged to, the non-AP MLD and forwarded to the distribution system.
